(19) United States
(12) Patent Application Publication
(10) Pub. No.: US 2026/0034788 A1
(43) Pub. Date: Feb. 5, 2026

(54) PRINTING APPARATUS

(71) Applicant: CANON KABUSHIKI KAISHA, Tokyo (JP)

(72) Inventors: MASAAKI MATSUURA, Kanagawa (JP); MASAKAZU TSUKUDA, Kanagawa (JP); HIROTAKA ENDO, Kanagawa (JP); KEN TAKENAGA, Kanagawa (JP); TOMOYA HARA, Kanagawa (JP); TOSHIKI HAMANISHI, Kanagawa (JP); KATSUAKI SUKEGAWA, Kanagawa (JP)

(73) Assignee: CANON KABUSHIKI KAISHA, Tokyo (JP)

(21) Appl. No.: 19/283,080

(22) Filed: Jul. 28, 2025

(30) Foreign Application Priority Data
Jul. 31, 2024 (JP) 2024-124718
Feb. 20, 2025 (JP) 2025-025939

(51) Int. Cl. B41J 2/17; B41J 2/185; B65H 31/34

(52) U.S. Cl. CPC B41J 2/1721; B41J 2/185; B65H 31/34; B41J 2002/1856

(57) ABSTRACT

A printing apparatus includes a conveying unit configured to convey a printing medium in a first direction; a printing unit configured to print the printing medium conveyed by the conveying unit, a maintenance unit configured to maintain the printing unit, and a first stacking unit configured such that the printing medium printed by the printing unit is stacked thereon at a first position and a second position which is different from the first position in a second direction intersecting the first direction, wherein the maintenance unit is on one side of the first stacking unit in the second direction.

### BACKGROUND

### Field of the Technology

The present disclosure relates to a printing apparatus.

### Description of the Related Art

There is known a technique that in a printing apparatus in which a printing medium after printing is discharged and stacked on a stacking unit, the printing medium is sorted for every certain number of sheets by moving the stacking unit. Japanese Patent Laid-Open No. 2015-160715 (hereinafter, referred to as Document 1) discloses a technique of ensuring, in the case of sorting a printing medium, a region in which a bundle of the printing medium to be sorted from now is not placed over an already sorted bundle of the printing medium by moving a stacking unit obliquely relative to a conveyance direction.

However, the apparatus disclosed in Document 1 is a relatively large image forming apparatus. For this reason, there is a possibility that the size of the apparatus is increased by employing the configuration of Document 1.

### SUMMARY

The present disclosure addresses the above-described problems, and provides a configuration which does not lead to an increase in size in a printing apparatus which is capable of sorting sheets.

A printing apparatus according to some embodiments of the present disclosure includes a conveyance unit configured to convey a printing medium in a first direction; a printing unit configured to print the printing medium conveyed by the conveyance unit; a maintenance unit configured to maintain the printing unit; and a first stacking unit configured such that the printing medium printed by the printing unit is stacked thereon at a first position and a second position which is different from the first position in a second direction intersecting the first direction, wherein the maintenance unit is placed over part of the first stacking unit in a height direction on one side of the first stacking unit in the second direction.

Features of the present disclosure will become apparent from the following description of embodiments with reference to the attached drawings. The following description of embodiments is described by way of example.

### BRIEF DESCRIPTION OF THE DRAWINGS

FIG. 1 is a perspective view showing an internal configuration of a printing apparatus.

FIGS. 2A and 2B are a front view and a plan view of a printing unit.

FIGS. 3A and 3B are diagrams for explaining a conveyance system of the printing unit.

FIG. 4 is a block configuration diagram mainly showing a control system of a stacking unit in the printing unit.

FIG. 5 is a perspective configuration diagram of the stacking unit.

FIGS. 6A and 6B are diagrams for explaining a range of movement in a front tray.

FIGS. 7A and 7B are diagrams for explaining sorting positions of the stacking unit.

FIG. 8 is a perspective configuration diagram of a drive transmission unit.

FIGS. 9A and 9B are plan views of constituent members of the drive transmission unit.

FIG. 10 is a perspective configuration diagram of a cam.

FIGS. 11A to 11C are diagrams for explaining a movement of a reciprocating member by the cam.

FIG. 12 is a diagram for explaining a drive of the stacking unit in a rotational direction of a drive source.

FIG. 13 is a diagram showing the relationship between FIGS. 13A and 13B; FIGS. 13A and 13B are flowcharts showing a processing content of a printing process.

FIGS. 14A to 14F are diagrams showing states after the drive of the stacking unit in the printing process.

FIG. 15 is a perspective view of a maintenance unit.

FIG. 16 is a perspective view of an ink discharge unit.

FIGS. 17A and 17B are perspective views of a liquid storing unit.

FIGS. 18A and 18B are perspective views of the printing unit.

FIGS. 19A and 19B are schematic diagrams of the printing apparatus.

FIG. 20 is a diagram for explaining another configuration for extending and contracting the stacking unit.

FIG. 21 is a diagram for explaining another configuration for moving the stacking unit in an X direction.

FIGS. 22A to 22C are diagrams for explaining a configuration for sorting a printing medium stacked on the stacking unit.

FIGS. 23A and 23B are diagrams for explaining another configuration for sorting the printing medium stacked on the stacking unit.

### DESCRIPTION OF THE EMBODIMENTS

Hereinafter, various exemplary embodiments, features, and aspects of a printing apparatus, a control method, and a program will be described in detail with reference to the attached drawings. Note that the following embodiments are not intended to limit the present disclosure, and all combinations of features described in the present embodiments are not necessarily essential for the solution to problem of the present disclosure. In addition, positions, shapes, and the like of components described in the embodiments are mere examples, and are not intended to limit the scope of the present disclosure to these examples.

In the present embodiment, a multi-function printer having a printing function of ejecting an ink as a printing agent to print a printing medium by using an inkjet system and a reading function of reading an original document placed on a platen glass will be described as an example of a printing apparatus. Note that the printing system is not limited to an inkjet system, and may be any of various known systems such as an electrophotographic system, for example. The printing agent which can be ejected in the printing apparatus according to the present embodiment is not limited to an ink, and encompasses various known printing agents used for printing such as a processing liquid for applying predetermined processing to an ejected ink.

In the present specification, the description is made by defining a direction directed from the left side to the right side of the printing apparatus as an X direction, a direction directed from the depth side (rear side) to the near side (front side) of the printing apparatus as a Y direction, and a direction directed from the lower side to the upper side of the printing apparatus as a Z direction, when facing the side where the printing medium after printing is discharged. In this way, the X direction, the Y direction, and the Z direction are directions directed from one side to the opposite side, and are also directions orthogonal to one another. In the present specification, each direction is expressed with “+” in the case of being directed from one side to the opposite side, and is expressed with “−” in the case of being directed from the opposite side to the one side, as appropriate.

In the present specification, the usability refers to usefulness and ease of use as defined as “the extent to which a system, product or service can be used by specified users to achieve specified goals with effectiveness, efficiency and satisfaction in a specified context of use” in ISO 9241-11.

### First Embodiment

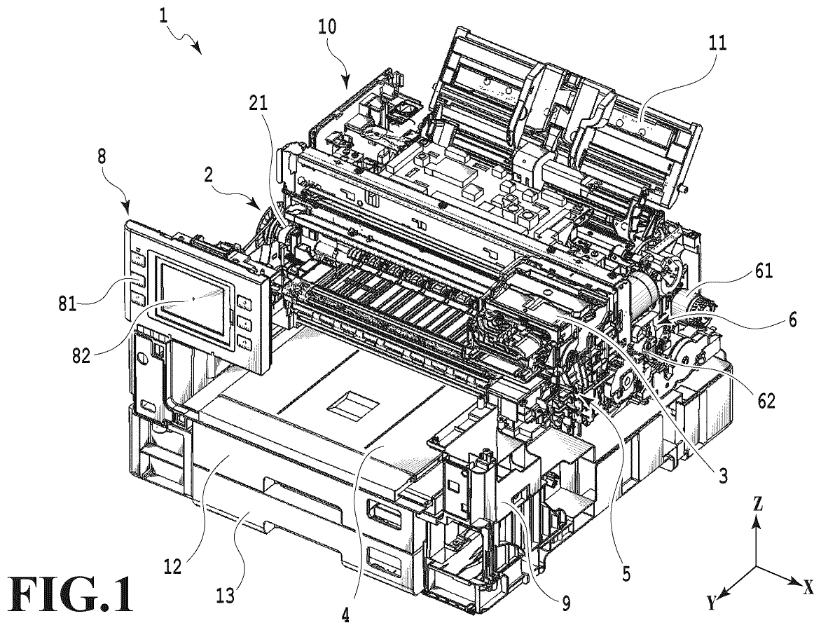

First, a printing apparatus according to a first embodiment will be described with reference to FIGS. 1 to 19.

### (Configuration of Printing Apparatus)

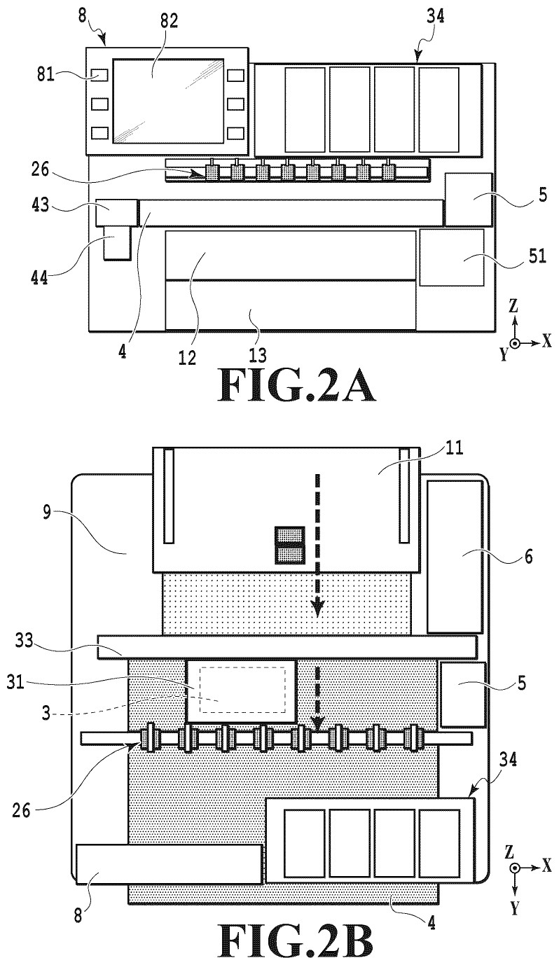

A schematic configuration of the printing apparatus according to the present embodiment will be described. FIG. 1 is a perspective view showing an internal configuration of the printing apparatus. FIG. 2A is a front view of a printing unit. FIG. 2B is a plan view of the printing unit. Note that in FIG. 1, part of the configuration is omitted for facilitating the understanding.

The printing apparatus 1 is a multi-function printer including a printing unit 10 which prints a printing medium, and a scanner unit (not shown) which is disposed above the printing unit 10 and reads an original document. The printing apparatus 1 executes various processes regarding the printing operation and the reading operation by using the printing unit 10 and the scanner unit individually or in combination.

The scanner unit includes an ADF (auto document feeder) and a FBS (flat head scanner), and can read an original document which is automatically fed by the ADF and read an original document placed on a platen glass of the FBS by the user. Note that although the printing apparatus 1 is a multi-function printer including the printing unit 10 and the scanner unit in the present embodiment, the printing apparatus 1 may have a configuration which does not include the scanner unit.

The printing unit 10 includes a first sheet feeding unit 11, a second sheet feeding unit 12, and a third sheet feeding unit 13 which feed a printing medium (see FIG. 1). In addition, the printing unit 10 includes a conveyance unit 2 which conveys the printing medium fed from each sheet feeding unit, a printing head 3 which ejects an ink to print the printing medium conveyed by the conveyance unit 2, and a stacking unit 4 on which to stack the printed printing medium. Moreover, the printing unit 10 includes a maintenance unit 5 which maintains the printing head 3, and a drive unit 6 which drives the first sheet feeding unit 11, the second sheet feeding unit 12, the third sheet feeding unit 13, and the maintenance unit 5.

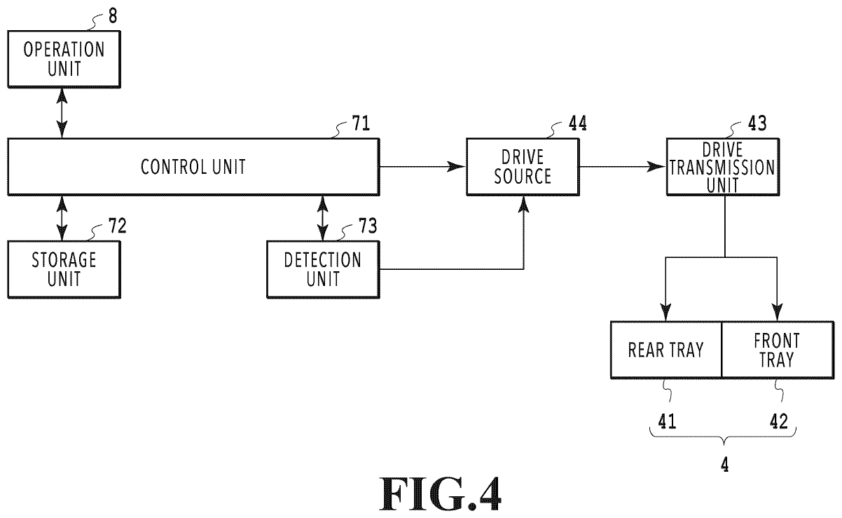

The printing unit 10 includes a liquid storing unit 34 which stores the ink to be supplied to the printing head 3, and an ink discharge unit 51 (waste liquid storing unit) which stores the ink discharged from the maintenance unit 5 (see FIGS. 2A and 2B). In addition, the printing unit 10 includes a control unit 71 (see FIG. 4) which conducts controls of the operation of the entire printing apparatus 1 such as drive control of the conveyance unit 2, the printing head 3, the stacking unit 4, and the drive unit 6. Moreover, the printing unit 10 includes an operation unit 8 which can display an input operation by the user and various types of information. The operation unit 8 is provided with operation buttons 81 for inputting operation information into the printing apparatus 1 and a display panel 82 which displays the operation information. In the printing apparatus 1, the above-described configurations are fastened to a housing 9 to configure the printing unit 10.

In the printing unit 10, the operation unit 8 and the liquid storing unit 34 are disposed above the stacking unit 4. More specifically, the operation unit 8 and the liquid storing unit 34 are disposed at positions where parts of the operation unit 8 and the liquid storing unit 34 are placed over the stacking unit 4 in the XY plane (see FIG. 2B). Note that the operation unit 8 and the liquid storing unit 34 are disposed at distances from the stacking unit 4 in the Z direction (see FIG. 2A). In the present embodiment, the operation unit 8 is disposed on one side (the left side) in the X direction, and the liquid storing unit 34 is disposed on the opposite side (the right side) in the X direction. Note that the positions at which the operation unit 8 and the liquid storing unit 34 are disposed in the X direction may be reversed from each other.

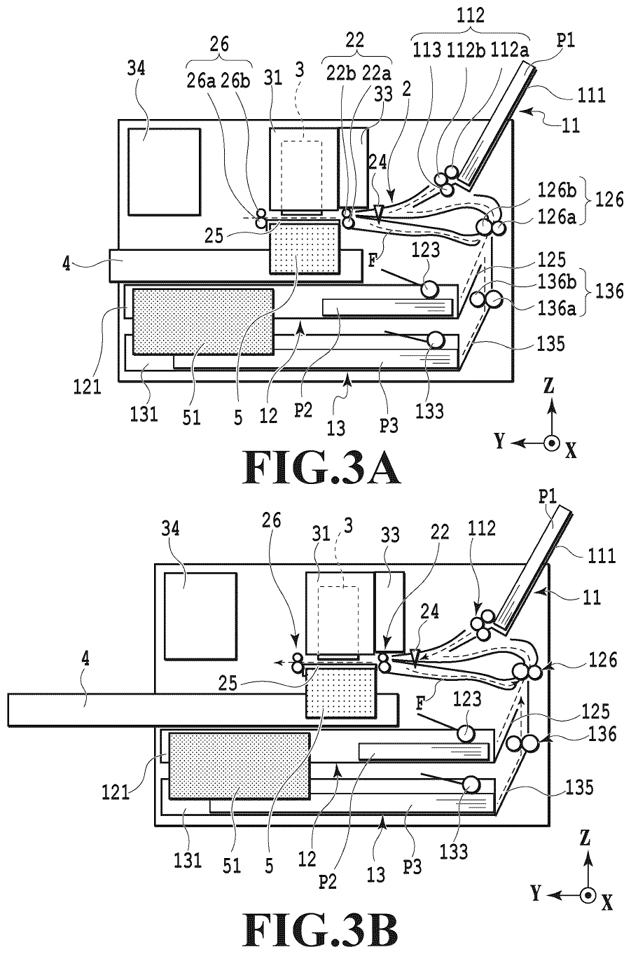

In addition, in the printing unit 10, the operation unit 8 and the liquid storing unit 34 are disposed on the opposite side (the front side) from a discharge roller pair 26 in the Y direction, that is, on the downstream side of the printing medium discharged by the discharge roller pair 26 in the conveyance direction. Moreover, in the printing unit 10, the maintenance unit 5 is disposed within a region where the printing head 3 moves, and on the opposite side to the stacking unit 4 in the X direction. More specifically, the maintenance unit 5 is disposed at a position where part of the maintenance unit 5 is placed over the stacking unit 4 in the YZ plane (see FIG. 3A). That is, the stacking unit 4 is at least partially placed over the maintenance unit 5 in the Y direction. In addition, the stacking unit 4 is at least partially placed over the maintenance unit 5 in the Z direction. Furthermore, in the printing unit 10, the ink discharge unit 51 is disposed below the stacking unit 4. More specifically, the ink discharge unit 51 is disposed at a position where part of the ink discharge unit 51 is placed over the stacking unit 4 in the XY plane (see FIG. 2A and FIG. 3A).

### (Conveyance Unit and Sheet Feeding Unit)

Next, a configuration of the conveyance system of the printing unit 10 will be described. FIGS. 3A and 3B are diagrams showing the configuration of the conveyance system of the printing unit 10. FIG. 3A shows a state before the stacking unit 4 extends, and FIG. 3B shows a state after the stacking unit 4 extended.

### <Conveyance Unit>

The conveyance unit 2 includes a conveyance roller pair 22 which conveys the printing medium fed from each sheet feeding unit to a printing position where the printing head 3 can print, and the discharge roller pair 26 which discharges the printing medium after being printed by the printing head 3. The conveyance roller pair 22 includes a conveyance roller 22a which is driven by a conveyance motor 21 (see FIG. 1), and a pinch roller 22b which is in press contact with and follows the conveyance roller 22a. The conveyance roller pair 22 pinches (nips) and conveys the printing medium with the conveyance roller 22a and the pinch roller 22b. The discharge roller pair 26 includes a discharge roller 26a which is driven by the conveyance motor 21, and a spur 26b which is in press contact with the discharge roller 26a. The discharge roller pair 26 pinches and conveys the printing medium with the discharge roller 26a and the spur 26b.

In addition, the conveyance unit 2 includes a first intermediate roller pair 126 which conveys the printing medium fed from the second sheet feeding unit 12 and the third sheet feeding unit 13 to the conveyance roller pair 22, and a second intermediate roller pair 136 which conveys the printing medium fed from the third sheet feeding unit 13 to the first intermediate roller pair 126. The first intermediate roller pair 126 includes a first intermediate roller 126a which is driven by the drive unit 6, and a first driven roller 126b which is in press contact with and follows the first intermediate roller 126a. The first intermediate roller pair 126 pinches and conveys the printing medium with the first intermediate roller 126a and the first driven roller 126b. In addition, the second intermediate roller pair 136 includes a second intermediate roller 136a which is driven by the drive unit 6, and a second driven roller 136b which is in press contact with and follows the second intermediate roller 136a. The second intermediate roller pair 136 pinches and conveys the printing medium with the second intermediate roller 136a and the second driven roller 136b.

Note that after the printing medium fed from each sheet feeding unit passes through the detection lever 24 which is located upstream of the conveyance roller pair 22 in the conveyance direction, the positions of the right and left end portions thereof in the width direction of the printing medium are aligned by the conveyance roller pair 22 relative to the conveyance direction. That is, the skew of the printing medium in the conveyance direction is corrected by the conveyance roller pair 22.

### <Sheet Feeding Unit>

### =First Sheet Feeding Unit=

The first sheet feeding unit 11 includes a pressing plate 111 on which the printing medium is placed, and a first sheet feeding roller unit 112 which feeds the printing medium placed on the pressing plate 111 to the conveyance roller pair 22. The first sheet feeding roller unit 112 includes first sheet feeding rollers 112a and 112b which feed the printing medium to the conveyance roller pair 22. In addition, the first sheet feeding roller unit 112 includes a separating roller 113 which is disposed at a position facing the first sheet feeding roller 112b and applies a resistance to the printing medium fed by the first sheet feeding roller 112b. The first sheet feeding rollers 112a and 112b are driven by drive force of a drive motor 61 (see FIG. 1) of the drive unit 6.

In the first sheet feeding unit 11, the feeding of the printing medium P1 is started by causing the printing medium P1 stacked on the pressing plate 111 to abut the first sheet feeding roller 112a rotating upon receiving the drive of the drive motor 61. The printing medium P1 fed by the first sheet feeding roller 112a is fed by the first sheet feeding roller 112b which is disposed downstream of the first sheet feeding roller 112a in a sheet feeding direction. At this time, only one sheet at the uppermost position in the printing medium P1 fed by the first sheet feeding roller 112b is fed to the conveyance roller pair 22 by the separating roller 113 disposed at a position facing the first sheet feeding roller 112b.

### =Second Sheet Feeding Unit=

The second sheet feeding unit 12 includes a cassette case 121 which stores the printing medium, a second sheet feeding roller 123 which feeds the printing medium stored in the cassette case 121, and a separating unit 125 which applies a resistance to the printing medium fed by the second sheet feeding roller 123. The printing medium is stored in the printing apparatus via a front face 9a of the housing 9. The front face 9a of the housing 9 is a face which faces the user in the case where the user operates the operation unit 8. Here, the cassette case 121 is configured to be drawn out from the front face of the housing 9 in the Y direction. In this case, a discharge direction of the printing medium to the stacking unit 4 coincides with a drawing-out direction of the cassette case 121. Note that a configuration for inserting the printing medium into the cassette case 121 through the front face of the cassette case 121 may be employed. The second sheet feeding roller 123 is driven by the drive force of the drive motor 62 (see FIG. 1) of the drive unit 6 being transmitted thereto via a gear train (not shown).

In the second sheet feeding unit 12, the feeding of the printing medium P2 to the first intermediate roller pair 126 is started by the second sheet feeding roller 123 which abuts the printing medium P2 stored in the cassette case 121 and rotates upon receiving the drive of the drive motor 62. To the printing medium P2 fed by the second sheet feeding roller 123, a resistance is applied in the sheet feeding direction by the separating unit 125. In this way, even in the case where a plurality of sheets of the printing medium P2 are fed by the second sheet feeding roller 123, the separating unit 125 causes one sheet at the uppermost position in the printing medium P2 to be fed to the first intermediate roller pair 126. The printing medium P2 fed to the first intermediate roller pair 126 is conveyed to the conveyance roller pair 22 by the first intermediate roller pair 126.

### =Third Sheet Feeding Unit=

The third sheet feeding unit 13 includes a cassette case 131 which stores the printing medium, a third sheet feeding roller 133 which feeds the printing medium stored in the cassette case 131, and a separating unit 135 which applies a resistance to the printing medium fed by the third sheet feeding roller 133. The third sheet feeding roller 133 is driven by the drive force of the drive motor 62 (see FIG. 1) of the drive unit 6 being transmitted thereto via a gear train (not shown).

In the third sheet feeding unit 13, the feeding of the printing medium P3 to the second intermediate roller pair 136 is started by the third sheet feeding roller 133 which abuts the printing medium P3 stored in the cassette case 131 and rotates upon receiving the drive of the drive motor 62. To the printing medium P3 fed by the third sheet feeding roller 133, a resistance is applied in the sheet feeding direction by the separating unit 135. In this way, even in the case where a plurality of sheets of the printing medium P3 are fed by the third sheet feeding roller 133, the separating unit 135 causes one sheet at the uppermost position in the printing medium P3 to be fed to the second intermediate roller pair 136. The printing medium P3 fed to the second intermediate roller pair 136 is conveyed to the conveyance roller pair 22 by the second intermediate roller pair 136 and the first intermediate roller pair 126.

### (Printing Head)

Next, the printing head 3 will be described. In the printing unit 10, the printing head 3 is mounted on a carriage 31 which is slidably supported by a chassis 33 extending in the X direction, and is configured to be capable of reciprocating in the X direction (see FIG. 2B and FIG. 3A). In this way, the printing head 3 is capable of reciprocating in the X direction by means of the carriage 31. The printing medium conveyed by the conveyance roller pair 22 is supported by a platen 25 provided at a position facing the printing head 3. Then, the printing head 3 conducts printing by ejecting the ink to print the printing medium supported by the platen 25 while moving in the X direction by means of the carriage 31.

In the case of conducting printing on only one surface of the printing medium, the printing medium after the printing is discharged onto the stacking unit 4 via the discharge roller pair 26. On the other hand, in the case of conducting printing on both surfaces of the printing medium, the conveyance motor 21 is rotated in a reverse direction in the state where a trailing end of the printing medium is pinched by the discharge roller pair 26. In this way, the discharge roller pair 26 and the conveyance roller pair 22 rotate in the opposite direction to the case where the printing medium is conveyed in the conveyance direction, to convey the printing medium, the trailing end of which is pinched by the discharge roller pair 26, in a reverse conveyance path F. In the description here, the trailing end of the printing medium means a trailing end of the printing medium in the conveyance direction (the +Y direction), and a leading end of the printing medium means a leading end of the printing medium in the conveyance direction.

Then, once the leading end of the printing medium conveyed in the reverse conveyance path F passes through the conveyance roller pair 22, the rotation of the conveyance motor 21 is switched to a forward rotation. Thereafter, once the printing medium is conveyed by the first intermediate roller pair 126 and passes through the detection lever 24, skew correction is conducted again by the conveyance roller pair 22. After this, the same operation as the printing on one surface of the printing medium is conducted to print the other surface of the printing medium, and the printing medium which has been printed on both surfaces is discharged onto the stacking unit 4 by the discharge roller pair 26.

Note that although the detail will be described later, in the present embodiment, the stacking unit 4 onto which the printing medium discharged via the discharge roller pair 26 is discharged automatically extends in the +Y direction at the time of printing (see FIG. 3B). In this way, the stacking unit 4 most of which has been inside the housing 9 before the extension protrudes to the outside of the housing 9, so that the area on which the printing medium can be stably stacked is provided. Note that the stacking unit 4 can be attached to and detached from the housing 9. By detaching the stacking unit 4 from the housing 9, the user can insert the hand into the housing 9 and remove the printing medium jammed in a conveyance path.

### (Stacking Unit)

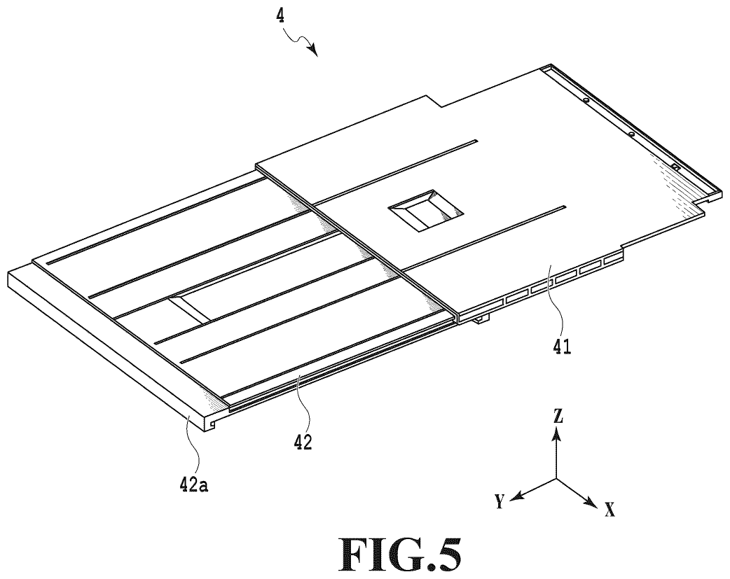

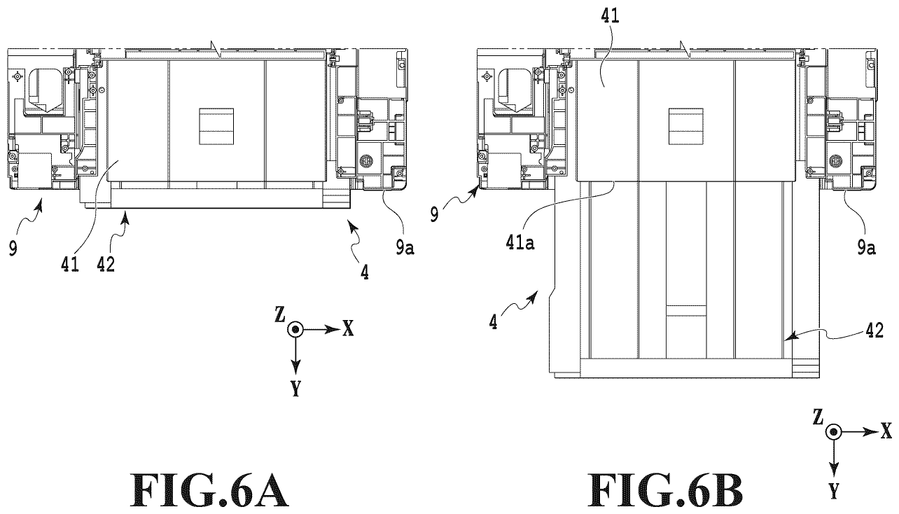

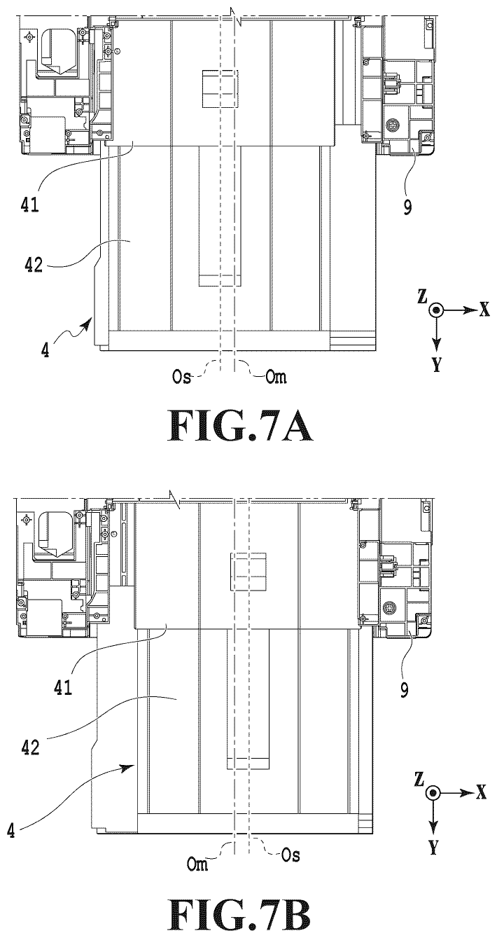

Next, the stacking unit 4 will be described. FIG. 4 is a block diagram showing a configuration of a control system of the printing apparatus 1. Note that since the stacking unit 4 will be mainly described in the following description, FIG. 4 mainly shows a control configuration on the stacking unit 4, and the other configurations are omitted. FIG. 5 is a perspective configuration diagram of the stacking unit 4. FIGS. 6A and 6B are diagrams showing a position of the stacking unit 4 after extension and a position of the stacking unit 4 after contraction. FIG. 6A shows a housing position of a front tray 42 after the contraction of the stacking unit 4, and FIG. 6B shows a stacking position of the front tray 42 after the extension of the stacking unit 4. FIGS. 7A and 7B are diagrams showing two sorting positions of the stacking unit 4. FIG. 7A shows a first sorting position, and FIG. 7B shows a second sorting position.

Once the printing is started, the stacking unit 4 onto which the printing medium discharged by the discharge roller pair 26 is stacked automatically extends, so that the area on which the discharged printing medium is supported is expanded. In addition, once the printing medium is removed from the stacking unit 4, the stacking unit 4 automatically contracts, so that the area is reduced. Moreover, the stacking unit 4 has a function of moving in a direction (the X direction) intersecting (in the present embodiment, orthogonally intersecting) the extension and contraction direction (the Y direction) of the stacking unit 4 to sort the discharged printing medium. Note that in the printing unit 10, the automatic contraction of the stacking unit 4 is also executed in the cases where an instruction has been received from the user via the operation unit 8, where the printing operation has not been conducted for a predetermined period of time, the mode has been switched to a power saving mode, and the like besides the case where the printing medium has been removed from the stacking unit 4.

The printing unit 10 includes the control unit 71, a storage unit 72, a detection unit 73, the operation unit 8, the stacking unit 4, a drive transmission unit 43, and a drive source 44 (see FIG. 4).

The operation unit 8 includes the operation buttons 81 and the display panel 82 (see FIG. 1). The user can select whether the sorting of the printing medium is desired and instruct the movement of the stacking unit 4 by operating the operation unit 8. Note that in the printing unit 10, the sorting of the printing medium and the movement of the stacking unit 4 can be executed based on information set in a job, for example. The storage unit 72 stores various programs for operating the stacking unit 4. Upon an input by the user from the operation unit 8, the control unit 71 reads a program in accordance with a result of the input, and conducts the drive control of the stacking unit 4. In addition, the storage unit 72 holds the result of detection by the detection unit 73.

The detection unit 73 includes a plurality of sensors. Specifically, the detection unit 73 includes a sensor which detects rotation of the drive source 44 (see FIG. 2A) for driving the stacking unit 4. This sensor is configured with a rotary encoder, and is installed on a rotation axis of the drive source 44 which generates the rotational drive. This sensor converts the rotational angle of the drive source 44 to the number of steps, and transmits the number of steps to the control unit 71. The control unit 71 reads the number of steps used for a predetermined operation of the stacking unit 4 from the storage unit 72, and in the case where the number of steps transmitted from the sensor reaches a specified number of steps, the control unit 71 determines that the predetermined operation of the stacking unit 4 has completed, and stops the drive source 44. Although in the present embodiment, this sensor is configured with an encoder provided on the rotation axis of the drive source 44, the sensor is not limited to this. For example, this sensor may be provided on a rotation axis of a predetermined transmission member included in the drive transmission unit 43 (see FIG. 2A) which transmits the drive force of the drive source 44 to the stacking unit 4.

In addition, the detection unit 73 includes a sensor which detects the position of the stacking unit 4 after the predetermined operation. As this sensor, a mechanical switch, a photosensor, or a rotary encoder of the drive source 44 can be used, for example. Moreover, the detection unit 73 includes a sensor which detects whether the printing medium is stacked on the stacking unit 4. This sensor makes it possible to detect the timing of contracting the stacking unit 4.

The stacking unit 4 includes a rear tray 41 and a front tray 42 (see FIG. 5). The rear tray 41 is configured to be capable of reciprocating in the X direction which intersects a direction (the Y direction) in which the printing medium is discharged. The rear tray 41 is disposed inside the housing 9, and an end portion 41a of the rear tray 41 on the opposite side in the Y direction is located rearward of the front face 9a of the housing 9 in the Y direction (see FIG. 6A).

The front tray 42 is supported on the rear tray 41, and is configured to be capable of reciprocating in the Y direction on the rear tray 41. This makes it possible for the front tray 42 to reciprocate in the X direction by means of the rear tray 41.

The front tray 42 is configured to be movable between the housing position and the stacking position (see FIG. 6A and FIG. 6B). The housing position is a position at which most part of the front tray 42 is placed over the rear tray 41 and housed below the rear tray 41 in the XY plane (see FIG. 6A). The stacking position is a position at which the front tray 42 is drawn out from the housing position to allow the printing medium to be stacked thereon in corporation with the rear tray 41 (see FIG. 6B). That is, in the case where the stacking unit 4 is extended, the front tray 42 moves from the housing position to the stacking position in the +Y direction. In addition, in the case where the stacking unit 4 is contracted, the front tray 42 moves from the stacking position to the housing position in the −Y direction. Note that in the present embodiment, a partial region of the front tray 42 on the end portion 42a side in the housing position protrudes more than the front face 9a of the housing 9 in the Y direction. In such a configuration, in the case where the front tray 42 is at the housing position, most part of the stacking unit 4 is located inside the housing 9, so that a space for installing the printing apparatus 1 can be reduced.

The stacking position can take a plurality of different positions in the Y direction depending on the size of the printing medium. In the present embodiment, the stacking position can take four stacking positions corresponding respectively to the A4, A5, B5, and LETTER sizes. Note that the positions which the stacking position can take are not limited to these.

In addition, the stacking unit 4 is configured to be movable between two sorting positions where to sort the discharged printing medium by the movement of the rear tray 41 in the X direction. That is, the stacking unit 4 is movable in the X direction between a first sorting position (see FIG. 7A) where a center position Os of the stacking unit 4 is located on one side relative to a center position Om of the discharged printing medium and a second sorting position (see FIG. 7B) where the center position Os is located on an opposite side relative to the center position Om. The stacking unit 4 is configured to be capable of sorting the discharged printing medium at positions displaced in the X direction by conducting the stacking of the printing medium at the first sorting position and the stacking of the printing medium at the second sorting position. That is, the first sorting position and the second sorting position are located away from each other at a predetermined distance in the X direction.

In the present embodiment, the distance from the center position Os to the center position Om at the first sorting position may be the same as the distance from the center position Os to the center position Om at the second sorting position. Alternatively the distance from the center position Os to the center position Om at the first sorting position may be different from the distance from the center position Os to the center position Om at the second sorting position. The distance used for the sorting, that is, the distance between the first sorting position and the second sorting position may be, for example, 30 mm or more and 50 mm or less. The position at which the stacking unit 4 can stay is not limited to the first sorting position and the second sorting position. For example, the stacking unit 4 may be configured to be located at the center position Om in the case of not sorting the printing medium during the printing process or in the case of not conducting the printing.

### (Drive Transmission Unit)

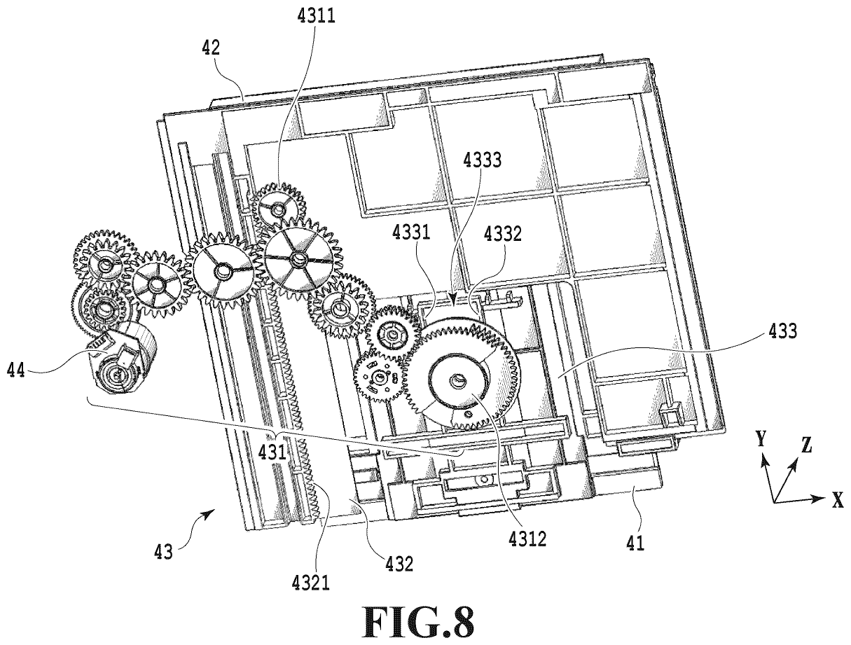

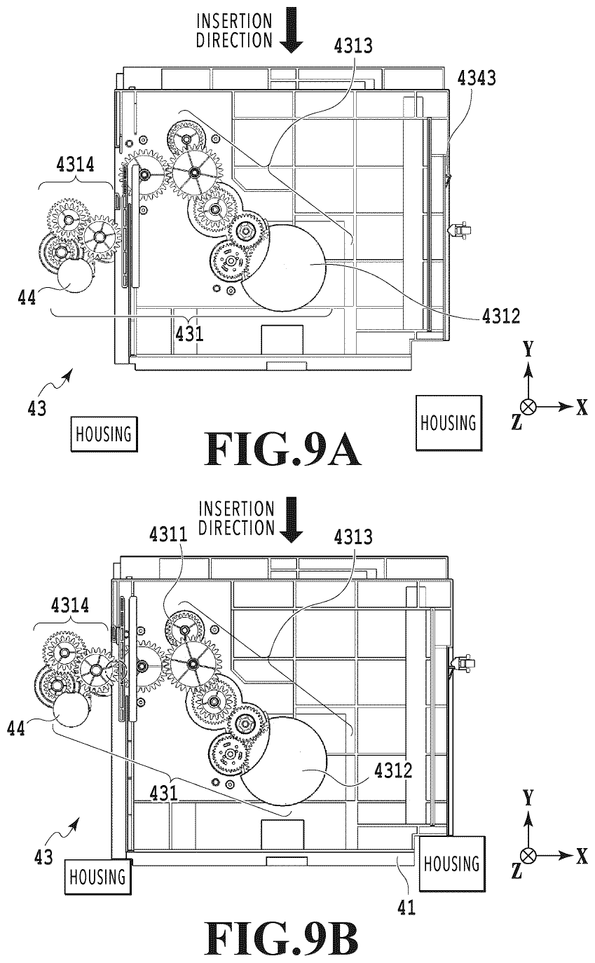

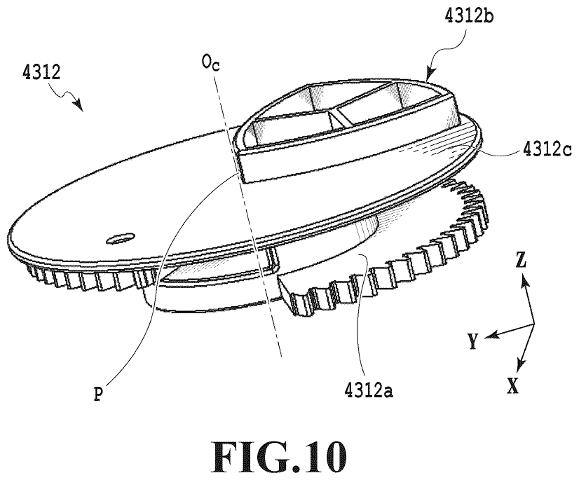

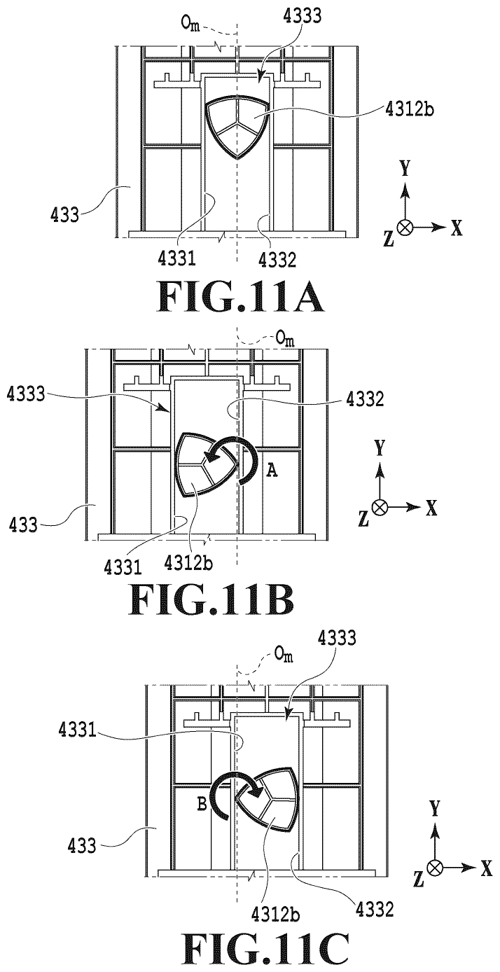

Next, the drive transmission unit 43 will be described. FIG. 8 is a perspective view of the drive transmission unit 43. FIGS. 9A and 9B are plan views showing constituent members of the drive transmission unit 43. FIG. 10 is a perspective view of a cam which is a constituent member of the drive transmission unit 43. FIGS. 11A to 11C are diagrams for explaining the movement of the stacking unit 4 in the X direction by means of the cam.

The drive transmission unit 43 includes a drive train 431 which is composed of a plurality of drive transmission members for transmitting a rotational drive from the drive source 44, and a supporting member 432 which is movable in the Y direction by means of the drive force transmitted via the drive train 431 (see FIG. 8). In addition, the drive transmission unit 43 includes a reciprocating member 433 which is movable in the X direction by means of the drive force transmitted via the drive train 431, and a case (not shown) which holds the drive source 44 and the drive train 431.

The supporting member 432 includes a rack portion 4321 which extends in the Y direction. This rack portion 4321 meshes with a pinion 4311, which is one of the drive transmission members included in the drive train 431, which makes it possible for the supporting member 432 to move in the Y direction by means of the drive force transmitted from the drive train 431. Specifically, the drive train 431 is composed of a plurality of gears including the pinion 4311. The drive force transmitted from the drive source 44 is transmitted to the pinion 4311 via a predetermined gear in the drive train 431, and the supporting member 432 moves in the Y direction by means of the drive force transmitted to the pinion 4311.

The drive train 431 includes a drive train 4313 of the stacking unit 4 and a drive train 4314 of the printing apparatus 1 (see FIGS. 9A and 9B). Before the stacking unit 4 is attached to the printing apparatus 1, the drive train 4313 of the stacking unit 4 and the drive train 4314 of the printing apparatus 1 are not connected with each other (see FIG. 9A). Then, once the stacking unit 4 is attached to the printing apparatus 1, the drive train 4313 of the stacking unit 4 and the drive train 4314 of the printing apparatus 1 are connected with each other (see FIG. 9B), which enables the drive train 431 to operate together.

One end of the drive train 431 is connected to the drive source 44. In addition, a cam 4312 which engages with the reciprocating member 433 is located at the other end of the drive train 431. The cam 4312 includes a circular plate portion 4312c, a gear portion 4312a which is formed on one surface of the plate portion 4312c, and a cam portion 4312b which is formed on the opposite surface of the plate portion 4312c (see FIG. 10). As the drive force from the drive source 44 is transmitted to the gear portion 4312a, the cam 4312 rotates about, as a rotation center, an axis Oc which is parallel with the Z direction passing through the center of the plate portion 4312c. In the present embodiment, the cam portion 4312b has a substantially triangular column shape, and its adjacent sides connecting vertices of the rectangle are gently curved in such a manner as to protrude outward (see FIG. 11A). Then, the cam portion 4312b is formed eccentrically relative to the rotation center on the other surface of the plate portion 4312c such that a predetermined vertex P is located on the axis Oc.

In the reciprocating member 433, an engagement portion 4333 with which the cam portion 4312b engages is formed. In the engagement portion 4333, a first sliding surface 4331 and a second sliding surface 4332 are formed to face each other at a predetermined interval in the X direction such that the cam portion 4312b which engages with the engagement portion 4333 can slide on the first sliding surface 4331 and the second sliding surface 4332. Note that the predetermined interval corresponds to the length of the cam portion 4312b in the X direction. In addition, the first sliding surface 4331 and the second sliding surface 4332 are formed in parallel with the Y direction. As described above, the cam portion 4312b is eccentric to the rotation center of the cam 4312. For this reason, as the cam 4312 rotates, the cam portion 4312b slides on the first sliding surface 4331 or the second sliding surface 4332 to move the reciprocating member 433 in the +X direction or the −X direction (see FIG. 11A to 11C).

For example, assume the case where the cam portion 4312b is rotated from a predetermined position (a position shown in FIG. 11A) in a direction of an arrow A (see FIG. 11B) by the rotation of the cam 4312. In this case, the cam portion 4312b slides on the first sliding surface 4331 to move the reciprocating member 433 from the opposite side to the one side (the −X direction) in the X direction (see FIG. 11B). In addition, assume the case where the cam portion 4312b is rotated from the predetermined position in a direction of an arrow B (see FIG. 11C) by the rotation of the cam 4312. In this case, the cam portion 4312b slides on the second sliding surface 4332 to move the reciprocating member 433 from the one side to the opposite side (the +X direction) in the X direction (see FIG. 11C).

The supporting member 432 is connected to the front tray 42. For this reason, in conjunction with the movement of the supporting member 432 in the Y direction, the front tray 42 moves in the Y direction. In addition, the reciprocating member 433 is connected to the rear tray 41. For this reason, in conjunction with the movement of the reciprocating member 433 in the X direction, the rear tray 41 moves in the X direction and the front tray 42 also moves in the X direction with the rear tray 41. In the present embodiment, the supporting member 432 is connected to the front tray 42, and the reciprocating member 433 is connected to the rear tray 41; however, the configuration is not limited to this. For example, the rack portion 4321 may be formed in the front tray 42 such that the front tray 42 has the function of the supporting member 432, or the engagement portion 4333 may be formed in the rear tray 41 such that the rear tray 41 has the function of the engagement portion 4333.

### (Overview of Drives of Rear Tray and Front Tray)

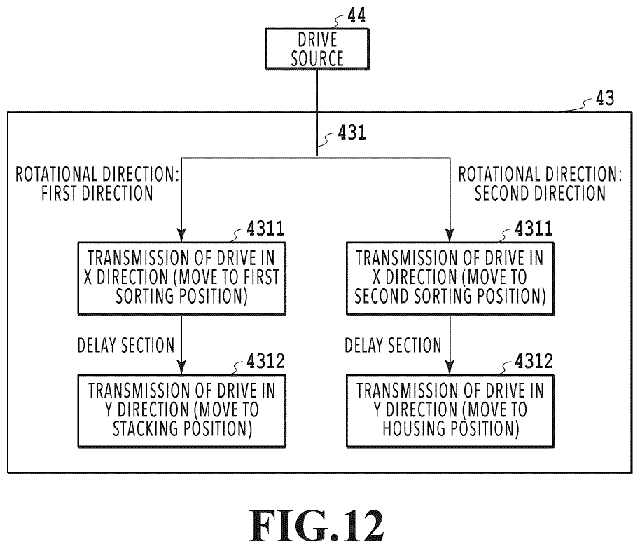

Next, an overview of drives of the rear tray 41 and the front tray 42 will be described. FIG. 12 is a diagram showing the overview of the drives of the rear tray 41 and the front tray 42.

In the drive train 431, a delay section is provided on a drive transmission path in the Y direction. Specifically, the drive train 431 is configured to start the movement of the front tray 42 in the Y direction after the movement of the rear tray 41 in the X direction is completed. More specifically, in the case where the rotational direction of the drive source 44 is a first direction, the rear tray 41 is moved to a first sorting position, and the front tray 42 is also moved to the first sorting position with the rear tray 41. Thereafter, by further rotation of the drive source 44 in the first direction, the front tray 42 is extended relative to the rear tray 41, that is, the front tray 42 at the housing position is moved in the +Y direction, and is moved to the stacking position. In the case where the rotational direction of the drive source 44 is a second direction which is opposite to the first direction, the rear tray 41 is moved to a second sorting position, and the front tray 42 is also moved to the second sorting position with the rear tray 41. Thereafter, by further rotation of the drive source 44 in the second direction, the front tray 42 is contracted relative to the rear tray 41, that is, the front tray 42 at the stacking position is moved in the −Y direction, and is moved to the housing position.

In the present embodiment, the drive transmission unit 43 moves the front tray 42 in the Y direction after moving the rear tray 41 in the X direction; however, the configuration is not limited to this. For example, the drive transmission unit 43 may be configured to move the rear tray 41 in the X direction after moving the front tray 42 in the Y direction. In addition, as the configuration for transmitting the drive force of the drive source 44, any of various known transmission mechanisms such as a link mechanism may be used. Moreover, the printing unit 10 may include a plurality of drive sources such that the movement of the rear tray 41 in the X direction and the movement of the front tray 42 in the Y direction are executed by using drive forces from different drive sources. Note that the movement of the rear tray 41 in the X direction and the movement of the front tray 42 in the Y direction do not have to be executed only by the drive source 44, but may be manually executed by a user.

### (Printing Process)

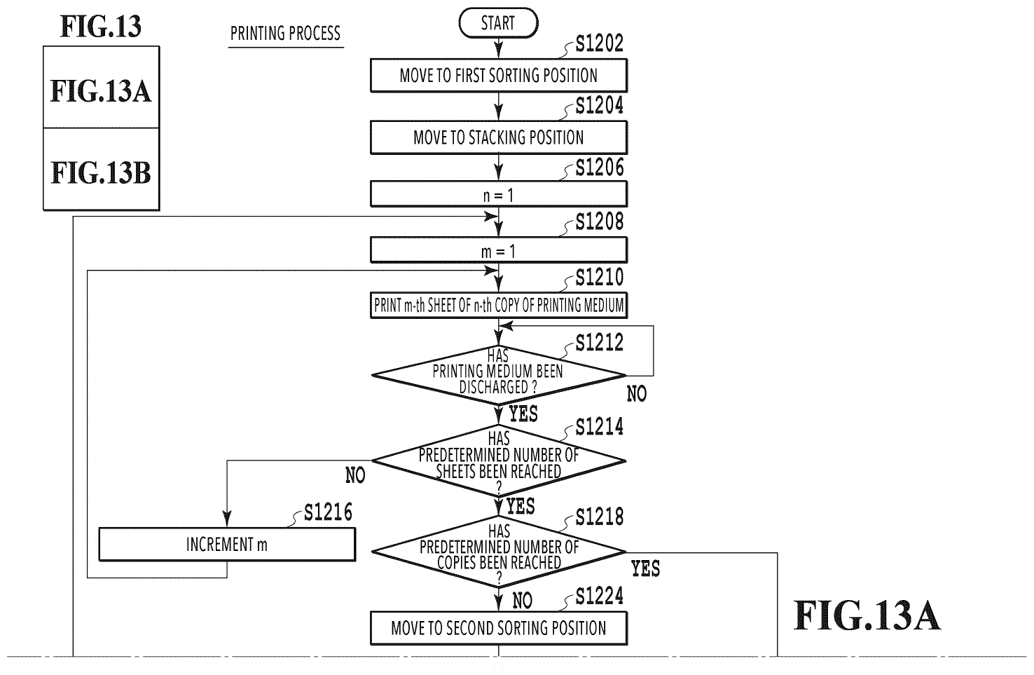

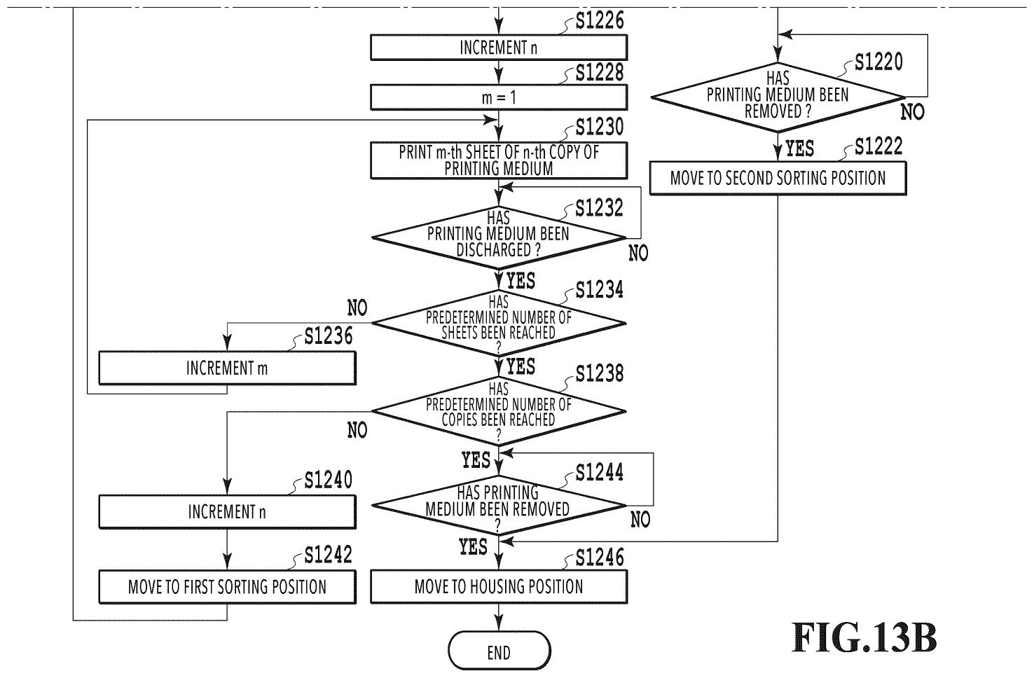

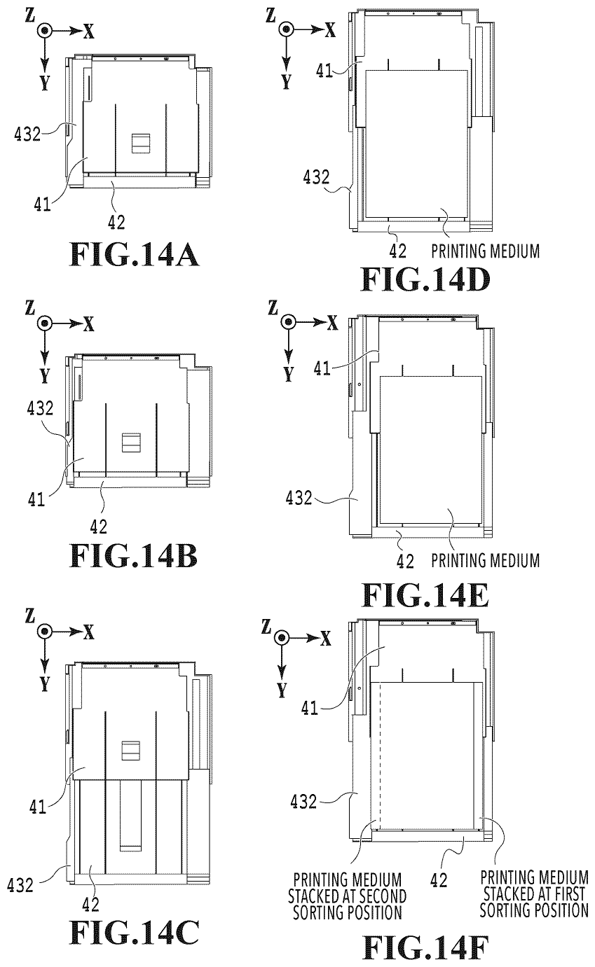

Next, a printing process of sorting the printing medium after printing in the stacking unit 4 while printing the printing medium will be described. FIGS. 13A and 13B are flowcharts showing a detailed processing content of the printing process of sorting the printing medium after printing in the stacking unit 4 while printing the printing medium. FIGS. 14A to 14F are diagrams showing a state after the movement of the stacking unit 4. The series of processing shown in the flowchart of FIG. 12 is conducted by the control unit 71 developing a program code stored in a program memory (not shown) of the storage unit 72 in a data memory (not shown) of the storage unit 72, and executing the program memory. Alternatively, functions of some or all of steps in FIG. 12 may be executed by using hardware, such as an ASIC (application-specific integrated circuit), an electrical circuit, or the like. In the present specification, the sign S in the description of each process in the flowchart refers to a step in the flowchart. Note that in the description of the printing process using FIGS. 13A and 13B, the case where a bundle of M sheets of the printing medium is regarded as one copy, and the printing process is executed by the printing apparatus 1 based on a job for executing printing to generate N copies of the bundles of the printing medium will be described.

Once the printing process is started, first in S1202, the control unit 71 moves the rear tray 41 and the front tray 42 to the first sorting position. In S1202, the drive source 44 is rotated in the first direction to move the rear tray 41 and the front tray 42, which have been located at an initial position (see FIG. 14A), in the −X direction to the first sorting position (see FIG. 14B). Next, in S1204, the control unit 71 moves the front tray 42 from the housing position to the stacking position. In S1204, in the state where the rear tray 41 and the front tray 42 are located at the first sorting position, the drive source 44 is further rotated in the first direction to move the front tray 42 in the +Y direction from the housing position to the stacking position (see FIG. 14C). In the present embodiment, the stacking position is changed depending on the size of the printing medium. That is, in the present embodiment, the amount of extension of the stacking unit 4 varies depending on the size of the printing medium. For this reason, in S1204, the stacking position is determined based on a result of detection by a sensor which detects the position of the stacking unit 4 after the predetermined operation in the detection unit 73. Specifically, for example, the front tray 42 is moved to the stacking position depending on the size of the printing medium based on the result of detection by the rotary encoder of the drive source 44. Alternatively, a configuration for moving the front tray 42 to the stacking position depending on the size of the printing medium based on a result of detection by a mechanical switch or a photosensor may be employed.

Here, the drive transmission unit 43 is formed such that the cam 4312 does not rotate further even if the drive force by the rotation of the drive source 44 in the first direction is transmitted thereto in the state where the rear tray 41 is located at the first sorting position. For this reason, even in the case where the drive source 44 rotates in the first direction in the state where the rear tray 41 and the front tray 42 are located at the first sorting position in S1204, the rear tray 41 and the front tray 42 do not move from the first sorting position in the −X direction.

Next, in S1206, the control unit 71 sets a variable n, which indicates the number of copies representing the bundle of the printing medium to be sorted from now, to “1”. In addition, in S1208, the control unit 71 sets a variable m, which indicates the number of sheets of the printing medium to be printed, to “1”. Thereafter, in S1210, the control unit 71 prints the m-th sheet of the n-th copy of the printing medium. The printing unit 10 conducts the printing operation of ejecting the ink to print a predetermined region of the printing medium which has been conveyed by the conveyance unit 2 and is supported by the platen 25 while moving the printing head 3 in the X direction. Next, a conveyance operation of conveying the printing medium by a predetermined amount corresponding to the length of the above-described predetermined region in the Y direction is conducted by the conveyance unit 2, and the printing operation is executed again. In this way, in the printing unit 10, the printing medium is printed by alternately and repeatedly executing the printing operation and the conveyance operation. Hence, the printing medium during the printing is being conveyed in the +Y direction in the proceeding of the printing, and is then discharged after the completion of the printing, and is stacked on the stacking unit 4 which has been extended and located at the first sorting position.

Then, in S1212, the control unit 71 determines whether the printing medium has been discharged. In S1212, for example, the determination is made based on a result of detection by a sensor which detects the discharge of the printing medium in the detection unit 73, and the number of sheets of the printing medium discharged is counted. The printing medium thus discharged is stacked on the stacking unit 4 located at the first sorting position (see FIG. 14D).

In the present embodiment, printing on the first sheet of the first copy of the printing medium is started after the rear tray 41 and the front tray 42 are moved to the first sorting position and the front tray 42 is moved to the stacking position; however, the configuration is not limited to this. The above-described movement of the rear tray 41 and the front tray 42 only has to be completed by the time the first sheet of the first copy of the printing medium is discharged onto the stacking unit 4, and this movement and the printing on the first sheet of the first copy of the printing medium may be executed in parallel. Note that “by the time the first sheet of the first copy of the printing medium is discharged onto the stacking unit 4” may refer to by the time the first sheet of the first copy of the printing medium is discharged and stacked onto the stacking unit 4, for example.

Thereafter, in S1214, the control unit 71 determines whether the number of sheets of the printing medium discharged has reached a predetermined number of sheets. In S1214, the control unit 71 determines whether the counts of sheets of the printing medium discharged has reached a predetermined number of sheets set in advance. Alternatively, in S1214, the control unit 71 may determine whether the number of sheets m has reached a predetermined number of sheets. In this case, in S1212, the counting of the number of sheets of the printing medium discharged is not conducted. The predetermined number of sheets is set based on information set in a job, for example. That is, in the present embodiment, the predetermined number of sheets is “M”, and in S1214, the control unit 71 determines whether m=M.

In S1214, if the control unit 71 determines that the number of sheets of the printing medium discharged has not reached the predetermined number of sheets, the processing proceeds to S1216, and the control unit 71 increments m, and returns to S1210. In addition, in S1214, if the control unit 71 determines that the number of sheets of the printing medium discharged has reached the predetermined number of sheets, the processing proceeds to S1218, and the control unit 71 determines whether the number of copies n has reached a predetermined number of copies. The predetermined number of copies is set based on information set in a job, for example. That is, in the present embodiment, the predetermined number of copies is “N”, and in S1218, the control unit 71 determines whether n=N.

In S1218, if the control unit 71 determines that the number of copies n has reached the predetermined number of copies, the processing proceeds to S1220, and the control unit 71 determines whether the printing medium has been removed from the stacking unit 4. In S1220, the determination is made based on a result of detection by a sensor which detects whether the printing medium has been stacked on the stacking unit 4 in the detection unit 73. In S1220, if the control unit 71 determines that the printing medium has not been removed from the stacking unit 4, the processing of S1220 is conducted again. At this time, notification to prompt the user to remove the printing medium from the stacking unit 4 may be conducted via the display panel 82 of the operation unit 8. In addition, in S1220, if the control unit 71 determines that the printing medium has been removed from the stacking unit 4, the processing proceeds to S1222, and the rear tray 41 and the front tray 42 are moved to the second sorting position. In S1222, the drive source 44 is rotated in the second direction to move the rear tray 41 and the front tray 42, which have been located at the first sorting position, in the +X direction to the second sorting position, and the processing proceeds to S1246, which will be described later.

In addition, in S1218, if the control unit 71 determines that the number of copies n has not reached the predetermined number of copies, the processing proceeds to S1224, and the control unit 71 moves the rear tray 41 and the front tray 42 to the second sorting position (see FIG. 14E). Since the specific processing content of S1224 is the same as that of the above-described S1222, the detailed description thereof is omitted. Next, in S1226, the control unit 71 increments the variable n. In addition, in S1228, the control unit 71 sets the variable m to “1”. Thereafter, in S1230, the control unit 71 prints the m-th sheet of the n-th copy of the printing medium. The printing medium during the printing is being conveyed in the +Y direction in the proceeding of the printing, and is discharged after the completion of the printing, and is stacked on the stacking unit 4 which has been extended and located at the second sorting position. Then, in S1232, the control unit 71 determines whether the printing medium has been discharged. The printing medium discharged here is stacked on the printing medium which was stacked on the stacking unit 4 at the first sorting position, and is stacked at a position displaced in the X direction from the printing medium which was stacked at the first sorting position (see FIG. 14F).

In the present embodiment, printing on the first sheet of the n-th copy of the printing medium is conducted after the rear tray 41 and the front tray 42 are moved to the second sorting position; however, the configuration is not limited to this. The movement of the rear tray 41 and the front tray 42 to the second sorting position only has to be completed at least by the time the first sheet of the n-th copy of the printing medium is discharged onto the stacking unit 4, and this movement and the printing on the first sheet of the n-th copy of the printing medium may be executed in parallel. Note that “by the time the first sheet of the n-th copy of the printing medium is discharged onto the stacking unit 4” may refer to by the time the first sheet of the n-th copy of the printing medium is discharged and placed on the printing medium which has been stacked on the stacking unit 4, for example.

Thereafter, in S1234, the control unit 71 determines whether the number of sheets of the printing medium discharged has reached the predetermined number of sheets. In S1234, if the control unit 71 determines that the number of sheets of the printing medium discharged has not reached the predetermined number of sheets, the processing proceeds to S1236, and the control unit 71 increments m, and returns to S1230. In addition, in S1234, if the control unit 71 determines that the number of sheets of the printing medium has reached the predetermined number of sheets, the processing proceeds to S1238, and the control unit 71 determines whether the number of copies n has reached the predetermined number of copies. Note that since the specific processing content from the above-described S1232 to S1238 is the same as that from the above-described S1212 to S1218, detailed description thereof is omitted.

In S1238, if the control unit 71 determines that the number of copies n has not reached the predetermined number of copies, the processing proceeds to S1240, and the control unit 71 increments n. Then, in S1242, the control unit 71 moves the rear tray 41 and the front tray 42 to the first sorting position, and returns to S1208. In S1242, the drive source 44 is rotated in the first direction to move the rear tray 41 and the front tray 42, which have been located at the second sorting position, in the −X direction to the first sorting position.

In the present embodiment, after the rear tray 41 and the front tray 42 are moved to the first sorting position in S1242, the processing returns to S1208, and printing is conducted on the first sheet of the n-th copy of the printing medium; however, the configuration is not limited to this. The movement of the rear tray 41 and the front tray 42 to the first sorting position in S1242 only has to be completed at least by the time the first sheet of the n-th copy of the printing medium is discharged onto the stacking unit 4, and this movement and the printing on the first sheet of the n-th copy of the printing medium may be executed in parallel.

In addition, in S1238, if the control unit 71 determines that the number of copies n has reached the predetermined number of copies, the processing proceeds to S1244, and the control unit 71 determines whether the printing medium has been removed from the stacking unit 4. Since the specific processing content of S1244 is the same as that of the above-described S1220, the detailed description thereof is omitted. In S1244, if the control unit 71 determines that the printing medium has not been removed from the stacking unit 4, the processing of S1244 is conducted again. At this time, notification to prompt the user to remove the printing medium from the stacking unit 4 may be conducted via the display panel 82 of the operation unit 8. In S1244, if the control unit 71 determines that the printing medium has been removed from the stacking unit 4, the processing proceeds to S1246, and the control unit 71 moves the front tray 42 from the stacking position to the housing position, and ends this printing process. Note that in the case of ending the printing process, for example, the rear tray and the front tray 42 which is located at the housing position are moved to the initial position (see FIG. 14A).

In S1246, the drive source 44 is further rotated in the second direction in the state where the rear tray 41 and the front tray 42 are located at the second sorting position to move the front tray 42 in the −Y direction from the stacking position to the housing position. Here, the drive transmission unit 43 is formed such that the cam 4312 does not rotate further even if the drive force by the rotation of the drive source 44 in the second direction is transmitted thereto in the state where the rear tray 41 is located at the second sorting position. For this reason, even in the case where the drive source 44 rotates in the second direction in the state where the rear tray 41 and the front tray 42 are located at the second sorting position in S1246, the rear tray 41 and the front tray 42 do not move from the second sorting position in the +X direction.

In this way, in the present embodiment, the control unit 71, the drive source 44, and the drive transmission unit 43 function as a control unit for controlling the movement of the stacking unit 4 including the rear tray 41 and the front tray 42.

### (Maintenance Unit)

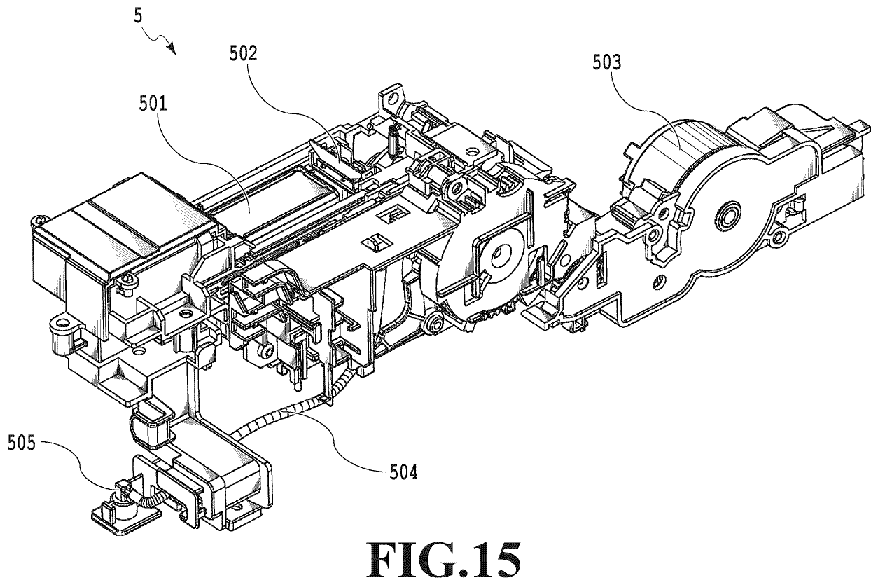

Next, the maintenance unit will be described. FIG. 15 is a perspective view of the maintenance unit 5.

The maintenance unit 5 includes a suction port 501 which comes into tight contact with the printing head 3, and a wiper 502 which cleans an ink ejection face of the printing head 3. In addition, the maintenance unit 5 includes a pump 503 which communicates with the suction port 501, a waste ink tube 504 which is connected at one end to the pump 503, and an ink discharge port 505 which is connected to the other end of the waste ink tube 504. The maintenance unit 5 conducts the cleaning operation for cleaning the ink ejection face periodically in the case where the printing head 3 does not conduct printing. In the cleaning operation, dust and the like which adhered to the ink ejection face of the printing head 3 are cleaned by the wiper 502. Then, the suction port 501 is brought into tight contact with the ink ejection face of the printing head 3 to bring the ink ejection face into a tightly enclosed state. In this state, by driving the pump 503 connected to the suction port 501, a suction pressure is applied inside the suction port 501 to suck dust attached to the ink ejection face and the ink stuck thereto, and the like. The waste ink thus sucked is discharged from the suction port 501 to the ink discharge port 505 via the waste ink tube 504. Moreover, the waste ink is discharged from the ink discharge port 505 to the ink discharge unit 51 (see FIG. 2A), which will be described later. After the waste ink is discharged from the suction port 501, residual droplets on the ink ejection face are further wiped by the wiper 502 to clean the ink ejection face. With these operations, the ejection face of the printing head 3 can be maintained in a favorable state.

### (Ink Discharge Unit)

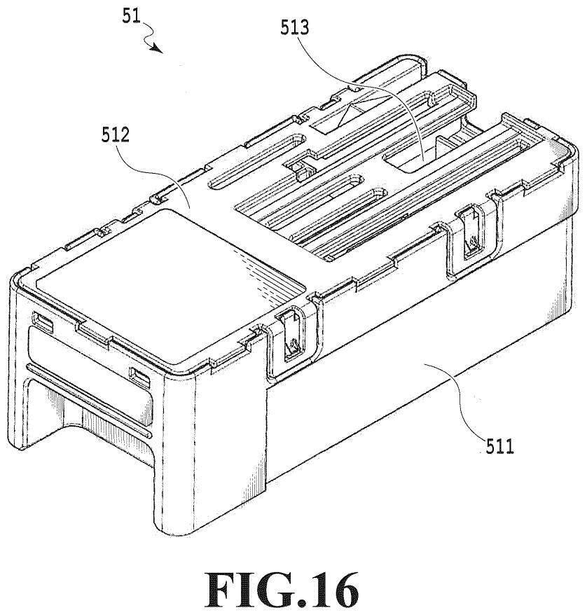

The ink discharge unit 51 will be described. FIG. 16 is a perspective view of the ink discharge unit 51.

The ink discharge unit 51 includes a waste ink case 511 which stores the waste ink, and a waste ink cover 512 which covers the waste ink case 511. In the waste ink case 511, an absorbent (not shown) for absorbing the waste ink is housed. The ink discharge unit 51 is attachable to and detachable from the printing apparatus 1. The ink discharge unit 51 is provided with an ink discharge port coupling portion 513 which is coupled with the aforementioned ink discharge port 505 (see FIG. 15) in the case where the ink discharge unit 51 is mounted on the printing apparatus 1. Into the waste ink case 511, the waste ink is discharged via the waste ink tube 504 and the ink discharge port 505 (see FIG. 15). The waste ink discharged into the waste ink case 511 is absorbed into the absorbent (not shown) included inside the waste ink case 511. When the waste ink has reached a predetermined amount, the control unit 71 notifies the user to replace the waste ink case 511, and the user replaces the waste ink case 511 to enable the use of the printing apparatus 1 again.

### (Liquid Storing Unit)

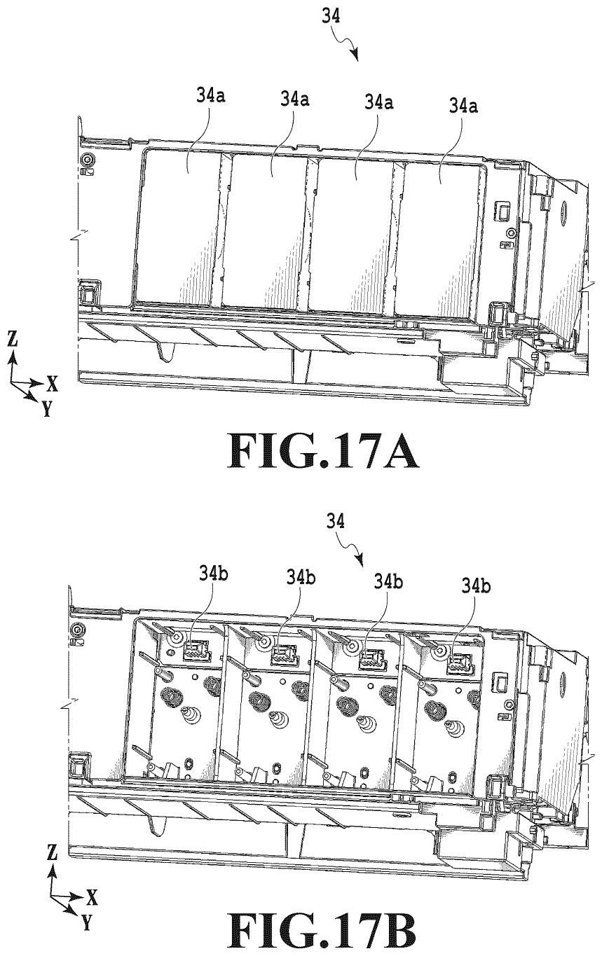

The liquid storing unit 34 (see FIG. 2) will be described. FIG. 17A is a perspective view showing a state where liquid containers 34a have been mounted on the liquid storing unit 34, and FIG. 17B is a perspective view showing a state where the liquid containers 34a have been detached from the liquid storing unit 34.

The liquid storing unit 34 includes the liquid containers 34a which store inks, and liquid container detecting units 34b which detect attachment and detachment of the liquid containers 34a. In the present embodiment, for conducting full-color printing, inks used for printing are inks of four colors of black (K), cyan (C), magenta (M), and yellow (Y), and these inks are stored in four liquid containers 34a, respectively. Although inks of four colors are used in the present embodiment, the configuration is not limited to this, and the colors of inks may be three colors or less, or may be five colors or more.

The liquid container detecting units 34b detect whether the liquid containers 34a have been correctly mounted. In the present embodiment, the liquid container detecting units 34b are composed of connectors, and the control unit 71 detects whether the liquid containers 34a have been mounted in accordance with the state of power distribution of the liquid container detecting units 34b. In the present embodiment, the liquid container detecting units 34b are composed of connectors; however, the configuration is not limited to this, and the mounting of the liquid containers 34a may be detected by using another detecting unit.

### (Printing Unit)

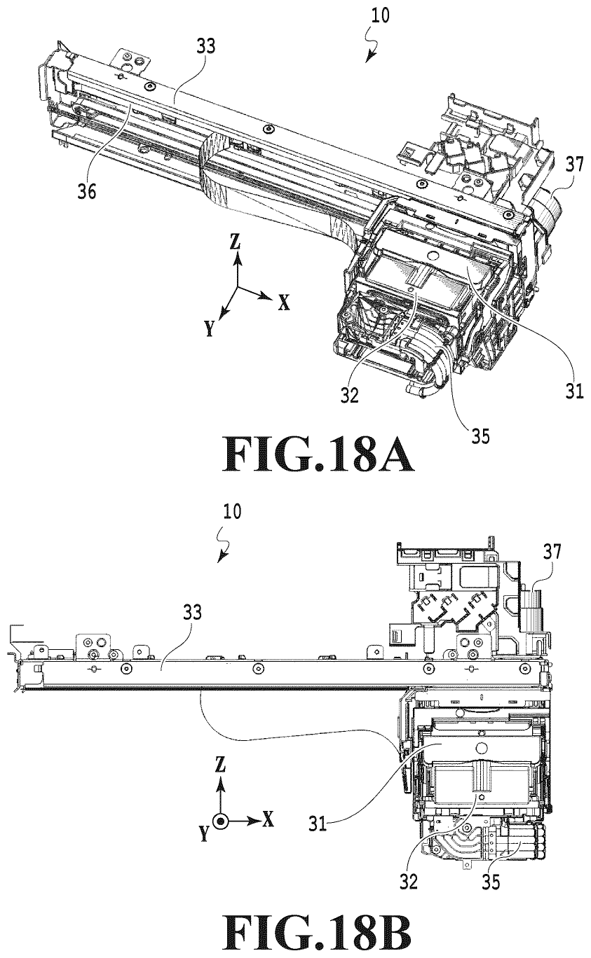

The printing unit 10 (see FIG. 2) will be described. FIG. 18A is a perspective view of the printing unit 10, and FIG. 18B is a top view of the printing unit 10.

The printing unit 10 includes the printing head 3 which conducts printing, the carriage 31 on which the printing head 3 is mounted, the chassis 33 which supports the carriage 31 and enables reciprocation, and a liquid supply tube 35 which supplies the inks of the liquid storing unit 34 to the printing head 3. Once the printing operation is started, the carriage 31 causes the printing head 3 to reciprocate in a scanning direction (the X direction) relative to the chassis 33. At this time, the carriage 31 reciprocates by means of a carriage motor 37 via a belt 36 provided inside the chassis 33. The inks inside the liquid storing unit 34 are supplied to the printing head 3 via the liquid supply tube 35. In this way, the printing unit 10 can supply the inks to the printing head 3 while causing the printing head 3 to reciprocate in the scanning direction (the X direction).

### (Arrangement of Each Unit of Printing Apparatus)

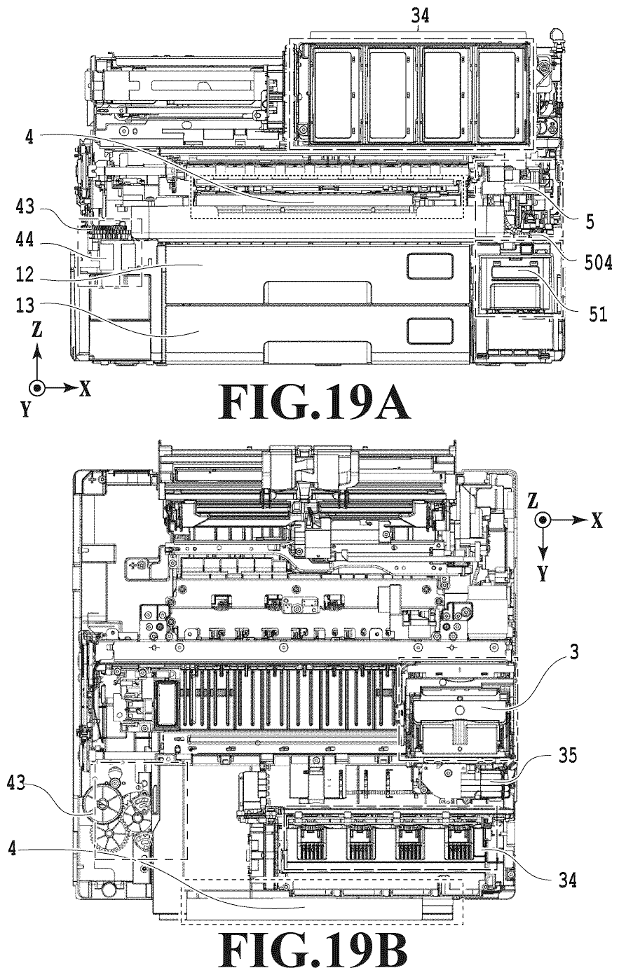

The arrangement of each unit of the printing apparatus of the present embodiment will be described. FIG. 19A is a schematic front view of the printing apparatus, and FIG. 19B is a schematic top view of the printing apparatus.

As viewed in a conveyance direction (the Y direction), the drive source 44 and drive transmission unit 43, and the maintenance unit 5 are arranged on the opposite sides with respect to the stacking unit 4. In addition, as viewed in the conveyance direction, the drive source 44 and drive transmission unit 43, and the ink discharge unit 51 are arranged on the opposite sides with respect to the stacking unit 4. As viewed in the conveyance direction, the drive source 44 and drive transmission unit 43, and the liquid storing unit 34 are arranged on the opposite sides with respect to the stacking unit 4. In the present embodiment, as shown in FIG. 19A, in the case where the printing apparatus 1 is viewed from the front side, that is, viewed in the −Y direction, the drive source 44 and the drive transmission unit 43 are arranged on the left side with respect to the stacking unit 4. In addition, the maintenance unit 5 and the ink discharge unit 51 are arranged on the right side with respect to the stacking unit 4. By such arrangement, the ink discharge path from the maintenance unit 5 to the ink discharge unit 51 can be shortened. In addition, by shortening the ink discharge path, the size of the printing apparatus 1 can be reduced.

On one side of the printing apparatus 1, the liquid storing unit 34, the maintenance unit 5 (which is the home position of the carriage, where the printing head 1 is attached and detached), and the ink discharge unit 51, which are operated by the user, are gathered. In addition, on the opposite side of the printing apparatus 1, the drive source 44 and the drive transmission unit 43, which are not operated by the user, are gathered. In this way, the region where the user operates can be made contact, and the usability can be improved while the size of the entire printing apparatus is reduced. Specifically, since the replacement of the liquid storing unit 34 and the ink discharge unit 51, the attachment and detachment of the printing head 1, and the like can be conducted on one side, it is possible to improve the usability. Since many users are right-handed in general, the region where the user operates is gathered on the right side; however, the region may be gathered on the right side or the left side.

As shown in FIGS. 3A and 3B, the movement region of the carriage 31 on which the printing head 3 is mounted is arranged above the maintenance unit 5. The above-mentioned cleaning operation on the printing head 3 is conducted in the case where the carriage 31 has been moved above the maintenance unit 5. As shown in FIG. 19A, in the case where the printing apparatus 1 is viewed from the front side, the liquid storing unit 34 is arranged on the upper right side with respect to the stacking unit 4. In this way, the ink supply path from the liquid storing unit 34 to the printing head 3 can be shortened, so that the ink supply time can be shortened. In addition, the ink supply path can be shortened, so that the size of the printing apparatus 1 can be reduced.

In this way, in the printing apparatus 1, the size of the apparatus can be reduced without lowering the usability. Note that although in the present embodiment, the drive source 44 and the drive transmission unit 43 are arranged on the left side and the maintenance unit 5, the ink discharge unit 51, and the liquid storing unit 34 are arranged on the right side, with respect to the stacking unit 4, the arrangement is not limited to this, and the arrangement may be reversed horizontally.

### Second Embodiment

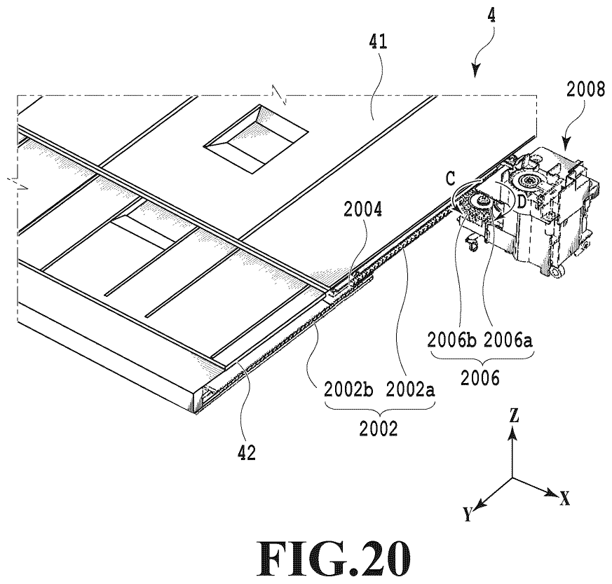

Next, a printing apparatus according to a second embodiment will be described with reference to FIG. 20. In the following description, for the same configurations as or corresponding configurations to the printing apparatus according to the above-described first embodiment, the same signs as those used in the above-described first embodiment are used, and detailed description thereof is omitted.

In the second embodiment, a configuration in which the stacking unit 4 in the first embodiment is extended and contracted in the Y direction by a drive mechanism which is provided on a side portion of the stacking unit 4, and in which the stacking unit 4 does not move in the X direction will be described. Hereinafter, a configuration of the drive mechanism of the stacking unit 4 according to the present embodiment will be described in detail.

### (Drive Mechanism of Stacking Unit)

The drive mechanism of the stacking unit 4 according to the present embodiment will be described. FIG. 20 is a diagram showing the drive mechanism for extending and contracting the stacking unit 4 in the Y direction according to the present embodiment. As the configuration for extending and contracting the stacking unit 4 in the Y direction, the present embodiment includes a rack 2002 which is provided on a side face of the stacking unit 4, and a drive member 2008 which includes a pinion configured to mesh with the rack.

More specifically, the rack 2002 is formed on a side face of the stacking unit 4 on the opposite side (the right side) in the X direction. The rack 2002 includes a first rack portion 2002a which is formed over a substantially entire side face of the rear tray 41 on the right side, and a second rack portion 2002b which is formed over a substantially entire side face of the front tray 42 on the right side. Note that in the first rack portion 2002a, a groove portion 2004 is formed on the front side of the first tooth. That is, a region in which teeth are not provided is formed on part on the front side of the side face of the rear tray 41 on the right side. Both of the first rack portion 2002a and the second rack portion 2002b are formed such that tooth tips thereof are directed to the right side. In addition, the first rack portion 2002a and the second rack portion 2002b are formed with the same pitch of the teeth.

On the housing 9, a drive member 2008 including gears 2006 which function as a pinion which meshes with the rack 2002 is fixedly provided. In the gears 2006, a gear 2006a and a gear 2006b are concentrically placed on each other in the vertical direction (Z direction). Both of the gear 2006a and the gear 2006b are formed to have the same pitch and diameter. The gear 2006a, which is located on the upper side, meshes with the first rack portion 2002a, and the gear 2006b, which is located on the lower side, meshes with the second rack portion 2002b. Note that in the state where the stacking unit 4 is at the housing position where the stacking unit 4 is housed inside the housing 9, while the gear 2006b meshes with the second rack portion 2002b, the tooth tips of the gear 2006a are caused to be located in the groove portion 2004, so that the gear 2006a does not mesh with the first rack portion 2002a.

### (Extension and Contraction of Stacking Unit)

In the above-described configuration, in the case where the stacking unit 4 extends in the Y direction, the drive motor (not shown) as the drive source, which is provided in the drive member 2008, rotates in a forward direction, and the drive force generated by the drive motor is transmitted to the gears 2006 via a plurality of gears (not shown). This cause the gear 2006a and the gear 2006b to rotate in a direction of an arrow C. Note that the drive member 2008 includes a plurality of gears which transmit the drive force generated by the drive motor to the gears 2006, together with the drive motor.

As the gear 2006a and the gear 2006b rotate in the direction of the arrow C, the front tray 42 is moved in the +Y direction by the second rack portion 2002b meshing with the gear 2006b in the stacking unit 4 located at the housing position. In the state where the stacking unit 4 is at the housing position, the gear 2006b and the first rack portion 2002a do not mesh with each other, so that the rear tray 41 does not move in the +Y direction.

Thereafter, as the front tray 42 moves by a predetermined amount in the +Y direction, the rear tray 41 moves in the +Y direction along with the movement of the front tray 42. This movement of the rear tray 41 causes the first rack portion 2002a to mesh with the gear 2006a, and the rotation of the gear 2006a in the direction of the arrow C causes the rear tray 41 to move in the +Y direction via the first rack portion 2002a. Note that as the rear tray 41 moves in the +Y direction, the front tray 42 also moves in the +Y direction together with the movement of the rear tray 41, so that the front tray 42 moves to a position where the front tray 42 is not located on the gears 2006 in the Y direction. This causes the second rack portion 2002b and the gear 2006b not to mesh with each other.

The amount of movement of the stacking unit 4 in the +Y direction, that is, the amount of extension varies depending on the size of the printing medium to be used. Note that the amount of extension is controlled, for example, based on a sensor (not shown) which is capable of detecting the amount of rotation of the drive motor or a gear provided in the drive member 2008, or the like.

In addition, in the case where the stacking unit 4 is contracted in the Y direction, the drive motor, which is provided in the drive member 2008, rotates in a reverse direction, and the drive force generated by the drive motor is transmitted to the gears 2006 via the plurality of gears. This causes the gear 2006a and the gear 2006b to rotate in a direction of an arrow D. As the gear 2006a and the gear 2006b rotate in the direction of the arrow D, the rear tray 41 is moved in the −Y direction by the first rack portion 2002a meshing with the gear 2006a. At this time, the front tray 42 moves in the −Y direction together with the movement of the rear tray 41 in the −Y direction.

Thereafter, once the gear 2006a is located in the groove portion 2004, the movement of the rear tray 41 in the −Y direction stops, but the second rack portion 2002b is caused to mesh with the gear 2006b. Hence, the rotation of the gear 2006b causes the front tray 42 to move in the −Y direction, and this movement of the front tray 42 in the −Y direction causes the front tray 42 and the rear tray 41 to move to the housing position. Note that in the present embodiment, the step of executing the movement to the first sorting position and the movement to the second sorting position in the printing process is omitted.

### (Modifications)

Although not particularly described in the above description, a configuration in which the user can select an automatic mode in which the above-described drive mechanism automatically extends and contracts the stacking unit 4 or a manual mode in which the user manually extends and contracts the stacking unit 4 may be employed. In this case, in the manual mode, for example, the gears 2006 are not caused to mesh with a gear which transmits the drive force in the drive member 2008.

In the above description, the stacking unit 4 is not moved in the X direction; however, the configuration is not limited to this, and a configuration in which the stacking unit 4 is moved in the X direction by using any of various known techniques may be employed. In addition, in the above description, the rear tray 41 and the front tray 42 are capable of moving in the Y direction together; however, the configuration is not limited to this. A configuration in which the rear tray 41 does not move in the Y direction, and only the front tray 42 is moved in the Y direction by the above-described drive mechanism may be employed.

### Third Embodiment

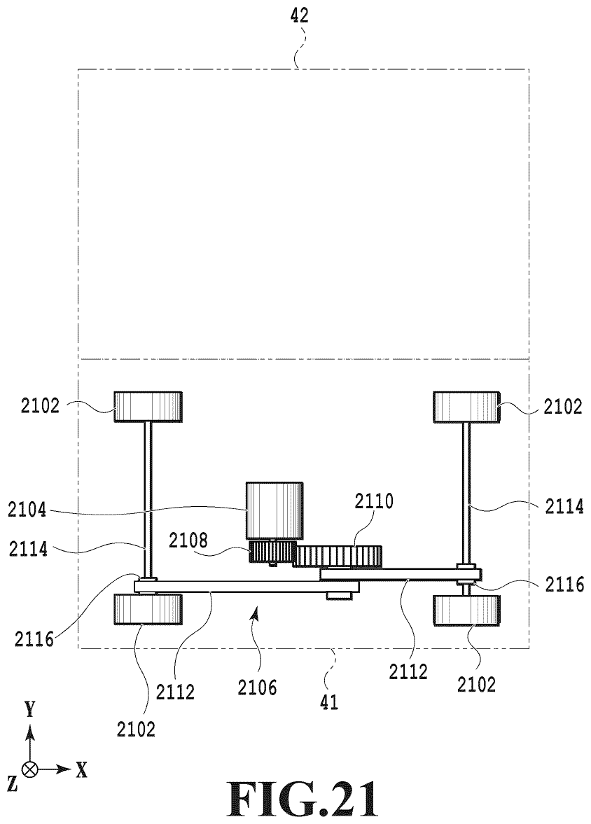

Next, a printing apparatus according to a third embodiment will be described with reference to FIG. 21. In the following description, for the same configurations as or corresponding configurations to the printing apparatus according to the above-described first embodiment, the same signs as those used in the above-described first embodiment are used, and detailed description thereof is omitted.

In the third embodiment, a configuration in which the stacking unit 4 in the first embodiment is moved in the X direction by a drive mechanism, and is not extended or contracted in the Y direction by the drive mechanism will be described. Hereinafter, a configuration of the drive mechanism of the stacking unit 4 according to the present embodiment will be described in detail.

### (Drive Mechanism of Stacking Unit)

The drive mechanism of the stacking unit 4 according to the present embodiment will be described. FIG. 21 is a diagram showing the drive mechanism for moving the stacking unit 4 in the X direction according to the present embodiment. As the configuration for moving the stacking unit 4 in the X direction, the present embodiment includes rollers 2102 which rotate to be capable of moving the rear tray 41 in the X direction, and a drive motor 2104 which drives the rollers 2102. Note that in the present embodiment, the front tray 42 is configured to be capable of being only manually extended and contracted relative to the rear tray 41.

More specifically, a plurality of rollers 2102 capable of moving the rear tray 41 in the X direction in the housing 9 are provided on a bottom face of the rear tray 41. In the present embodiment, each roller 2102 is disposed at a position which does not restrict the manual expansion and contraction of the front tray 42 on the bottom face of the rear tray 41. The rollers 2102 move on rails (not shown) which are provided on the housing 9 and extend in the X direction, for example.

In addition, on the bottom face of the rear tray 41, the drive motor 2104 which drives in accordance with the control of the control unit 71, and a transmission unit 2106 which transmits a drive force generated by the drive motor 2104 to the rollers 2102 are provided. The drive motor 2104 and the transmission unit 2106 are also disposed at positions which do not restrict the manual expansion and contraction of the front tray 42 on the bottom face of the rear tray 41.

### (Movement of Stacking Unit)

The drive motor 2104 rotates based on a drive signal from the control unit 71, which rotates a drive gear 2108, and the drive of the drive gear 2108 is transmitted to a drive transmission gear 2110. Then, the rotation of the drive transmission gear 2110 is transmitted, via a drive transmission belt 2112, to the gears 2116 joined to shafts 2114 which couple the rollers 2102. In this way, the shafts 2114 rotate, and the rollers 2102 rotate in conjunction with the rotations of the shafts 2114. Then, the rotations of the roller 2102 causes the rear tray 41 to move in the +X direction and the −X direction. The direction of movement of the rear tray 41 is changed depending on the direction of rotation of the drive motor 2104. For example, in the case where the drive motor 2104 rotates in the forward direction, the rear tray 41 moves in the +X direction, and in the case where the drive motor 2104 rotates in the reverse direction, the rear tray 41 moves in the −X direction.

In the present embodiment, in a step of executing a process of moving the front tray 42 to the stacking position and the housing position in the printing process, for example, notification to prompt the user to move the front tray 42 to the stacking position or the housing position is made on the display panel 82 of the operation unit 8. In addition, a sensor for detecting that the front tray 42 is at the stacking position or the housing position may be included. The movement at this time may be manually made by the user. In the state where the front tray 42 has been moved from the housing position to the stacking position, the rear tray 41 is moved in the X direction to sort the printing medium.

### (Modifications)

In the above description, the transmission unit 2106 composed of the rollers 2102, the drive motor 2107, the drive transmission gear 2110, and the like is provided on the bottom face of the rear tray 41; however, the configuration is not limited to this. For example, it is possible to include a moving unit which is configured to be movable in the X direction by this configuration, and to fixedly dispose the rear tray 41 on the moving unit.

In the above description, the stacking unit 4 does not automatically extend or contract in the Y direction; however, the configuration is not limited to this. A configuration in which the stacking unit 4 is automatically extended and contracted by using any of various known techniques may be employed. Note that a configuration in which the stacking unit 4 does not extend in the Y direction may be employed.

### Fourth Embodiment

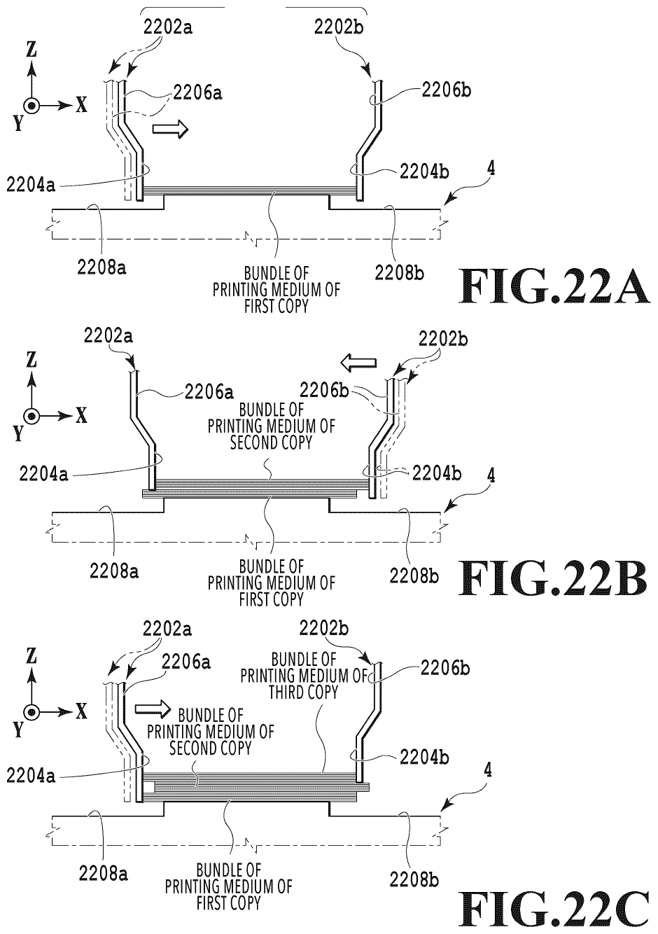

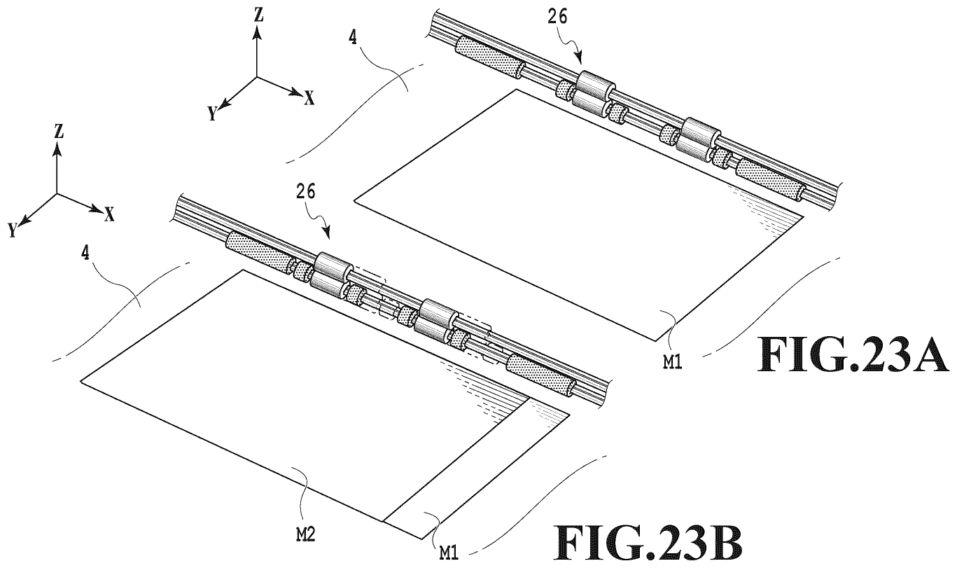

Next, a printing apparatus according to a fourth embodiment will be described with reference to FIGS. 22A to 22C and FIGS. 23A to 23B. In the following description for the same configurations as or corresponding configurations to the printing apparatus according to the above-described first embodiment, the same signs as those used in the above-described first embodiment are used, and detailed description thereof is omitted.

The fourth embodiment is different from the above-described first embodiment in that the printing medium to be discharged is sorted by a configuration different from the stacking unit 4. Hereinafter, the configuration for sorting the printing medium to be discharged will be described in detail.

### (Configuration for Sorting Printing Medium to be Discharged)

FIGS. 22A to 22C are diagrams for explaining an aligning member as an example of the configuration for sorting the printing medium to be discharged. FIG. 22A is a diagram showing the aligning member in the case of sorting a bundle of the printing medium of a first copy. FIG. 22B is a diagram showing the aligning member in the case of sorting a bundle of the printing medium of a second copy. FIG. 22C is a diagram showing the aligning member in the case of sorting a bundle of the printing medium of a third copy.

In the present embodiment, the printing apparatus 1 includes an aligning member 2202 which is capable of aligning end portions in the X direction of the printing medium discharged from the discharge roller pair 26. The aligning member 2202 includes a pair of aligning members 2202a and 2202b, and the aligning member 2202a and the aligning member 2202b are arranged to be opposite from each other, and are arranged such that an interval therebetween can be changed in the X direction.

The aligning members 2202a and 2202b are each formed of a plate-shaped member. The aligning member 2202a is provided, in a lower portion thereof, with an aligning portion 2204a for aligning the printing medium discharged onto the stacking unit 4, and the aligning member 2202b is provided, in a lower portion thereof, with an aligning portion 2204b for aligning the printing medium in cooperation with the aligning portion 2204a. The faces of the aligning portions 2204a and 2204b opposite to each other are flat faces. A plurality of sheets of the printing medium stacked on the stacking unit 4 are pressed on end sides in the X direction by the aligning portions 2204a and 2204b, so that the positions thereof are aligned in the X direction.

The aligning member 2202a is provided with a clearance portion 2206a which is located on one side in the X direction relative to the aligning portion 2204a above the aligning portion 2204a. In addition, the aligning member 2202b is provided with a clearance portion 2206b which is located on the other side in the X direction relative to the aligning portion 2204b above the aligning portion 2204b. In this way, the interval between the clearance portions 2206a and 2206b is wider than the interval between the aligning portions 2204a and 2204b in the X direction. In addition, the clearance portions 2206a and 2206b have a width reduced in the X direction as extending to lower sides from predetermined positions, and are connected respectively to the aligning portions 2204a and 2204b at lower end portions thereof.

In this way, in the aligning member 2202, the printing medium discharged between the clearance portions 2206a and 2206b is easily guided to between the aligning portions 2204a and 2204b.

The aligning member 2202 is disposed to be capable of executing various operations, which will be described later, in the housing 9. The operations of the aligning member 2202 are controlled by the control unit 71. The aligning member 2202 may be configured to be attachable and detachable, or may be configured not to be attachable and detachable.

On the upper face of the stacking unit 4 on which the printing medium is stacked, a recess portion 2208a which a front end of the aligning member 2202a can enter extends in the X direction on one side in the X direction. In addition, on the upper surface, a recess portion 2208b which a front end of the aligning member 2202b can enter extends in the X direction on the opposite side in the X direction. In the present embodiment, the recess portions 2208a and 2208b are provided on the rear tray 41.

In the printing process, in the case where printing is executed on the printing medium of the first copy, the aligning members 2202a and 2202b stand by at first receiving positions at which the aligning portions 2204a and 2204b are spaced at an interval that is longer than the width of the printing medium (the length in the X direction) by a predetermined amount. At this time, the front tray 42 is located at the stacking position. In addition, at this time, the front ends of the aligning members 2202a and 2202b have entered the recess portions 2208a and 2208b, respectively (see FIG. 22A).

The printing medium discharged from the discharge roller pair 26 enters between the clearance portions 2206a and 2206b of the aligning members 2202a and 2202b which have stood by at the first receiving position, and is discharged onto the upper face of the stacking unit 4 by its own weight. At this time, the aligning members 2202a and 2202b receive the printing medium discharged in a misaligned state to some extent in the X direction between the clearance portions 2206a and 2206b having a wider interval in the X direction, and guide the printing medium to between the aligning portions 2204a and 2204b. Thereafter, once the printing of the first copy is completed, the aligning members 2202a and 2202b are caused to press and align the bundle of the printing medium stacked on the stacking unit 4 in the +X direction by moving the aligning member 2202a in the +X direction such that the interval between the aligning portions 2204a and 2204b is narrowed.

Next, in transition to the printing of the second copy, the aligning members 2202a and 2202b are moved to a second receiving position which is displaced from the first receiving position for the first copy in the +X direction by a predetermined amount. At this time, the aligning member 2202a is moved such that the front end thereof is located on the printing medium of the first copy, and the aligning member 2202b is moved such that the front end thereof enters the recess portion 2208b (see FIG. 22B). Then, the printing medium discharged from the discharge roller pair 26 enters between the clearance portions 2206a and 2206b of the aligning members 2202a and 2202b which have stood by at the second receiving position, and is discharged onto the bundle of the printing medium of the first copy by its own weight. Thereafter, once the printing of the second copy is completed, the aligning members 2202a and 2202b are caused to press and align the bundle of the printing medium stacked on the bundle of the printing medium of the first copy in the −X direction by moving the aligning member 2202b in the −X direction such that the interval between the aligning portions 2204a and 2204b is narrowed.

Moreover, in transition to the printing of the third copy, the aligning members 2202a and 2202b are moved to the first receiving position. At this time, the aligning member 2202b is moved such that the front end thereof is located on the printing medium of the second copy, and the aligning member 2202a is moved such that the front end thereof enters the recess portion 2208a (see FIG. 18C). Then, the printing medium discharged from the discharge roller pair 26 enters between the clearance portions 2206a and 2206b of the aligning members 2202a and 2202b which have stood by at the first receiving position, and is discharged onto the bundle of the printing medium of the second copy by its own weight. Thereafter, once the printing of the third copy is completed, the aligning member 2202a, 2202b are caused to press and align the bundle of the printing medium stacked on the bundle of the printing medium of the second copy in the +X direction by moving the aligning member 2202a in the +X direction such that the interval between the aligning portions 2204a and 2204b is narrowed. In this way, the printing apparatus 1 can sort bundles of the printing medium in accordance with the number of copies.

### (Another Configuration for Sorting Printing Medium Discharged)

In addition, the configuration for sorting the printing medium discharged is not limited to the above-described aligning member 2202. For example, the discharge roller pair 26 may be configured to be movable in a direction orthogonal to the discharge direction of the printing medium such that in the case where the printing medium is discharged onto the stacking unit 4, the printing medium is sorted at at least two positions displaced from each other (see FIGS. 23A and 23B). FIGS. 23A and 23B are diagrams for explaining another configuration for sorting the printing medium discharged. FIG. 23A is a diagram for explaining discharge at a first position, and FIG. 23B is a diagram for explaining discharge at a second position.

Specifically, the discharge roller pair 26 is configured to be movable in the X direction. Then, in the case of discharging a printing medium Ml of an odd number of copy, the discharge roller pair 26 moves to the first position, which is located relatively on the right side, while discharging the printing medium M1, for example, and discharges the printing medium M1 onto the stacking unit 4. In this way, the printing medium M1 discharged is discharged at a position corresponding to the first position on the stacking unit 4 (see FIG. 23A). In addition, in the case of discharging a printing medium M2 an even number of copy, the discharge roller pair 26 moves to the second position, which is located relatively on the left side, while discharging the printing medium M2, for example, and discharges the printing medium M2 onto the stacking unit 4. In this way, the printing medium M2 is discharged at a position corresponding to the second position on the stacking unit 4 (see FIG. 23B). Note that for a specific configuration for moving the discharge roller pair 26 to different positions in the case of discharging a printing medium in accordance with the number of copy, since any of various known techniques can be used, detailed description thereof is omitted.

### Other Embodiments

Note that the above-described embodiments may be modified as described in the following (1) to (7).

(1) Although not particularly described in the above-described embodiments, in the printing apparatus 1, a printing process in which while printing is conducted on the printing medium, the printing medium after printing is sorted (see FIG. 12) and a printing process in which the sorting is not executed can be selected by means of an input on the operation unit 8 or the like. In the case of the printing process in which the sorting is not executed, for example, after front tray 42 is moved to the first sorting position, the printing medium after printing is continuously discharged in the state where the front tray 42 has been moved to the stacking position. In addition, in the case of the printing process in which the sorting is not executed, for example, if the control unit 71 determines that the number of copies n has not reached the predetermined number of copies in S1218, the processing proceeds to S1240. Moreover, in the case of the printing process in which the sorting is not executed, for example, S1202 and S1222 may be omitted.

Note that in the above-described embodiments, the case where an instruction to “sort the printing medium into N copies of M sheets” is inputted by a job or through the operation unit 8 has been described by using the flowchart of FIG. 12. However, in an actual printing operation, there is a case where an instruction not to sort is made even in the case where M and N are known. In such a case, a configuration for switching whether or not to transmit the drive force of the drive source 44 to the engagement portion 4333 may be provided in advance such that in the case where the sorting is not conducted, the stacking unit 4 is not moved between the first sorting position and the second sorting position.

(2) In the above-described embodiments, the drive transmission unit 43 is formed such that the cam 4312 does not rotate further even if the drive force by the rotation of the drive source 44 in the first direction is transmitted thereto in the state where the rear tray 41 is located at the first sorting position. However, the drive transmission unit 43 is not limited to such a configuration. For example, the drive transmission unit 43 may be formed such that the cam 4312 does not rotate further even if the drive force by the rotation of the drive source 44 in the first direction is transmitted thereto in the state where the rear tray 41 is located at a predetermined position on one side in the X direction relative to the first sorting position. In this case, in the printing process of FIG. 12, after the rear tray 41 is moved to the above-described predetermined position, the front tray 42 is moved from the housing position to the stacking position by further rotating the drive source 44 in the first direction. Thereafter, the rear tray 41 is moved in the +X direction to the first sorting position, by rotating the drive source 44 in the second direction. At this time, the position of the rear tray 41 is based on a result of detection of a sensor which detects the position of the stacking unit 4 after the predetermined operation in the detection unit 73.

(3) In the above-described embodiments, the drive transmission unit 43 is formed such that the cam 4312 does not rotate further even if the drive force by the rotation of the drive source 44 in the second direction is transmitted thereto in the state where the rear tray 41 is located at the second sorting position. However, the drive transmission unit 43 is not limited to such a configuration. For example, the drive transmission unit 43 may be formed such that the cam 4312 does not rotate further even if the drive force by the rotation of the drive source 44 in the second direction is transmitted thereto in the state where the rear tray 41 is located at a predetermined position on the opposite side in the X direction relative to the second sorting position.

(4) In the above-described embodiments, the front tray 42 is configured such that a region of part thereof on the end portion 42a side at the housing position protrudes forward from the housing 9 in the Y direction (see FIG. 6A); however, the configuration is not limited to this. The front tray 42 may be configured not to protrude forward from the housing 9 at the housing position. That is, in this case, the front tray 42 is completely housed inside the housing 9 at the housing position. In addition, although in the above-described embodiments, the stacking unit 4 is configured such that the printing medium discharged is sorted by stacking the printing medium at two positions, that is, the first sorting position and the second sorting position, the sorting positions are not limited to two positions. For example, the printing medium discharged may be sorted at three or more different positions in the X direction.

(5) In the above-described embodiments, the printing apparatus 1 may be a printing apparatus of a so-called serial scan-type, which conducts printing by ejecting the ink while moving the printing head 3 in the X direction relative to the transported printing medium; however, the printing apparatus 1 is not limited to this. The printing apparatus to which the present disclosure can be applied may be, for example, a printing apparatus of a so-called line-type, which conducts printing on a printing medium transported in the Y direction, by using a printing head which is capable of ejecting an ink in a range corresponding to the size of the printing medium on which printing can be conducted in the X direction.

(6) In the above-described embodiments, the first sorting position is configured such that the center position Os in the X direction of the stacking unit 4 is located on one side in the X direction relative to the center position Om of the printing medium discharged, and the second sorting position is configured such that the center position Os is located on the opposite side in the X direction relative to the center position Om. However, the first sorting position and the second sorting position are not limited to these. For example, one of the first sorting position and the second sorting position may be configured such that the center position Os coincides with the center position Om. In addition, in the above-described embodiments, a non-printing initial position at which no printing is conducted is located at such a position that the center position Os of the stacking unit 4 and the center position Os of the printing medium discharged coincide with each other; however, the configuration is not limited to this. The initial position may be the first sorting position, the second sorting position, or a predetermined position other than the first sorting position and the second sorting position.

(7) In the above-described embodiments, the case where an instruction to “sort the printing medium into N copies of M sheets” is set in a job has been described. However, the job may be in a form in which a command to change a sorting position is interposed between an image data of a predetermined page and an image data of the next page. In this case, the control unit 71 may sequentially execute operations in accordance with received commands, like executing printing and discharge in accordance with an image data of a predetermined page changing the sorting position, executing printing and discharge in accordance with the image data of the predetermined page, and then executing printing and discharge in accordance with an image data of the next page.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of priority from Japanese Patent Applications No. 2024-124718 filed Jul. 31, 2024, and No. 2025-025939 filed Feb. 20, 2025, which are hereby incorporated by reference herein in their entirety.

What is claimed is:

1. A printing apparatus comprising:
a conveying unit configured to convey a printing medium in a first direction;
a printing unit configured to print the printing medium conveyed by the conveying unit;
a maintenance unit configured to maintain the printing unit; and
a first stacking unit configured such that the printing medium printed by the printing unit is stacked thereon at a first position and a second position which is different from the first position in a second direction intersecting the first direction, wherein
the maintenance unit is on one side of the first stacking unit in the second direction.

2. The printing apparatus according to claim 1, wherein
the printing medium is stored in the printing apparatus via a front face of a housing, and
the conveying unit discharges the printing medium toward the front face in the first direction.

3. The printing apparatus according to claim 1, wherein the maintenance unit is placed over part of the first stacking unit in a height direction on the one side.

4. The printing apparatus according to claim 1, wherein the printing unit comprises a printing head which prints an image by ejecting a liquid while moving in the second direction.

5. The printing apparatus according to claim 1, wherein
the maintenance unit sucks a liquid from an ejection port disposed in the printing unit, and
the printing apparatus further comprises a waste liquid storing unit configured to store the liquid sucked by the maintenance unit, and
the waste liquid storing unit is disposed on an opposite side to the first stacking unit as viewed in the first direction.

6. The printing apparatus according to claim 5, wherein the first stacking unit moves from a housing position in the first direction.

7. The printing apparatus according to claim 5, wherein the printing unit is disposed above the maintenance unit.

8. The printing apparatus according to claim 5, wherein the maintenance unit is disposed above the waste liquid storing unit.

9. The printing apparatus according to claim 6, wherein the first stacking unit is drawn out by a user.

10. The printing apparatus according to claim 6, further comprising a drive unit configured to move the first stacking unit, wherein
the maintenance unit is disposed on an opposite side to the drive unit with respect to the first stacking unit as viewed from a downstream side in the first direction.

11. The printing apparatus according to claim 10, further comprising a moving mechanism configured to move the first stacking unit in the second direction.

12. The printing apparatus according to claim 11, further comprising a second stacking unit configured such that the printing medium is stacked thereon, wherein
the moving mechanism moves the first stacking unit together with the second stacking unit.

13. The printing apparatus according to claim 12, wherein the movement of the first stacking unit in the second direction and extension and contraction of the second stacking unit in the first direction are conducted by drive force of the drive unit.

14. The printing apparatus according to claim 10, further comprising a liquid storing unit configured to store the liquid to be supplied to the printing unit, wherein
the drive unit and the liquid storing unit are disposed on opposite sides with respect to the first stacking unit as viewed in the first direction.

15. The printing apparatus according to claim 14, wherein the liquid storing unit is disposed above the printing unit.

16. The printing apparatus according to claim 10, wherein the drive unit moves the first stacking unit in a width direction intersecting the first direction.

17. The printing apparatus according to claim 1, wherein at least part of the first stacking unit is placed over the maintenance unit in the first direction.

18. The printing apparatus according to claim 1, wherein the first stacking unit does not move in the second direction.

19. The printing apparatus according to claim 1, wherein
the printing unit prints the printing medium conveyed by the conveying unit, while moving in the second direction.
